(19) United States
(12) Patent Application Publication
(10) Pub. No.: US 2012/0224876 A1
(43) Pub. Date: Sep. 6, 2012

(54) IMAGE FORMING SYSTEM

(75) Inventors: Toshinori Nakayama, Kashiwa-shi (JP); Masami Hano, Abiko-shi (JP)

(73) Assignee: Canon Kabushiki Kaisha, Tokyo (JP)

(21) Appl. No.: 13/408,378

(22) Filed: Feb. 29, 2012

(30) Foreign Application Priority Data
Mar. 1, 2011 (JP) 2011-044183

(51) Int. Cl. G03G 15/20

(52) U.S. Cl. 399/69

(57) ABSTRACT

An image forming system includes a first image forming station including a first toner image forming portion for transferring the toner image onto a sheet, and a first image heating portion; a second image forming station including a second toner image forming portion onto the sheet received from the first image heating portion, and a second image heating portion; a controller capable of executing an operation in a first mode in which a predetermined image formation in accordance with an inputted image forming condition is effected using the first and second image forming stations, a second mode in which it is effected without using the second image forming portion; and a temperature controller for the second image heating portion in the second mode so as to be smaller than a temperature of the second image heating portion in the first mode.

### FIELD OF THE INVENTION AND RELATED ART

The present invention relates to an image forming system including serially connected image forming apparatuses each of which is capable of forming duplex printing (both side printing), more particularly to a temperature control for a fixing device of the image forming apparatus when the toner is used up during unattended operation.

An image forming apparatus which forms a toner image, transfers the toner image onto a recording material, and heat presses the image by the fixing device to fix the image on the recording material. An image forming apparatus is used widely wherein the recording material on which the image is fixed is reversed in its facing orientation and is refed into the same toner image forming portion by a reversion feeding mechanism to provide a duplex print (both sided print).

Japanese Laid-open Patent Application 2006-58881 discloses an image forming system including two image forming apparatuses connected in series with each other ray through a relay unit, each of the image forming apparatuses being capable of duplex printing. The relay unit is provided with the recording material reversion feeding mechanism and is capable of feeding the recording material from the first image forming apparatus into the second image forming apparatus.

In this system, a surface printing and a back side printing are carried out by the different image forming apparatuses respectively, by which the printing speed is significantly raised as compared with the case in which the both sides printing is carried out by one image forming apparatus using the reversion feeding mechanism.

With the image forming system of the Japanese Laid-open Patent Application 2006-58881, by using a large capacity recording material feeding device connected with the first image forming apparatus, the both sides printing can be carried out throughout night unattendedly.

However, if the toner is used up in either of the first image forming apparatus and the second image forming apparatus during the unattended night operation, the entire image forming system is shut down and does not recover until the next morning. As shown in FIG. 4, in the case of a full-color image forming apparatus, one comprises four toner bottles, and therefore, two apparatuses are used, eight toner bottles are used, and the probability of no-toner situation is quite high during the all night operation. Then, a larger part of the hopefully finished jobs are turned out unfinished in the morning. The capability of all night unattended operation results in disappointment.

### SUMMARY OF THE INVENTION

It has been proposed that if the no-toner situation occurs in the downstream second image forming apparatus during continuous both sides printing operation, the both sides printing is carried out only by the upstream first image forming apparatus using the reversion feeding mechanism, thus keeping the system operated. It has also been proposed that the operation is switched from a first mode in which the first image forming apparatus and the second image forming apparatus carry out the surface printing and the back side printing respectively, to a second mode in which the both sides printing is carried out only by the upstream first image forming apparatus.

However, when such a system is constructed and operated, it has been found that there is a glossiness difference between the both sides print image outputted using both of the image forming apparatuses and the both sides print image outputted using the upstream first image forming apparatus only.

Accordingly, it is a principal object of the present invention to provide an image forming system with which the difference between the output images produced in the first mode and in the second mode.

According to an aspect of the present invention, there is provided an image forming system comprising a first image forming station including a first toner image forming portion for forming a toner image and for transferring the toner image onto a recording material, and a first image heating portion for heating the toner image formed on the recording material by said first toner image forming portion; a second image forming station including a second toner image forming portion for forming a toner image and for transferring the toner image formed by said second toner image forming portion onto the recording material received from said first image heating portion, and a second image heating portion for heating the toner image formed on the recording material by said second toner image forming portion; a controller capable of executing an operation in a first mode in which a predetermined image formation in accordance with an inputted image forming condition is effected using said first image forming station and said second image forming station, a second mode in which the predetermined image formation is effected without using said second toner image forming portion; and a temperature controller for controlling a temperature of said second image heating portion in the second mode so as to be smaller than a temperature of said second image heating portion in the first mode.

These and other objects, features, and advantages of the present invention will become more apparent upon consideration of the following DESCRIPTION OF THE PREFERRED EMBODIMENTS of the present invention, taken in conjunction with the accompanying drawings.

### BRIEF DESCRIPTION OF THE DRAWINGS

FIG. 1 is an illustration of an image forming system structure.

FIG. 2 is an illustration of structures of image forming apparatuses.

FIG. 3 is an illustration of a structure of a fixing device.

FIG. 4 is an illustration of a structure of a full-color image formation portion.

FIG. 5 is an illustration of another example of a relay unit.

FIG. 6 is a block diagram of a control system for the image forming system.

FIG. 7 is an illustration of an operation panel for the image forming system.

FIG. 8 is a flow chart of a control in a first mode operation.

FIG. 9 is a flow chart of the control in a second mode operation.

FIG. 10 is a flow chart of the control in a third mode operation.

FIG. 11 is an illustration of a relation between a fixing operation number and a contraction amount of the recording material.

FIG. 12 is a flow chart of a stop avoiding control according to Embodiment 1 of the present invention.

FIG. 13 is a flow chart of the stop avoiding control according to Embodiment 2.

FIG. 14 is an illustration of a viscosity/temperature property of the toner.

FIG. 15 is a schematic view of a measuring device used in the measurement of toner temperature during fixing operation.

FIG. 16 is an illustration of a relation between the surface temperature of the fixing roller and the toner temperature.

### DESCRIPTION OF THE PREFERRED EMBODIMENTS

The preferred embodiments of the present invention will be described in conjunction with the accompanying drawings. Here, the dimensions, the sizes, the materials, the configurations, the relative positional relationships of the elements in the following embodiments and examples are not restrictive to the present invention unless otherwise stated. The present invention is implementable with partly modified structures as long as the temperature of the image heating portion provided in toner image forming portion when it is not used is controlled to a level lower than the temperature when it is used.

The present invention is effective to provide a solution to a problem arising from contraction difference or the like as well as the glossiness difference. The toner image forming portion may form a full-color or monochromatic images, may use a one component developer or a two component developer, may be of a direct transfer type or an intermediary transfer type, or the like, irrespective of a recording material feeding type, charging type, exposing type, photosensitive member kind or the like. Two image forming apparatuses may be connected with each other through a relay unit or may be directly connected with each other, and a first toner image forming portion, a first image heating portion, a second toner image forming portion and a second image heating portion may be contained in one casing. The image forming station may be used with various equipment and casing structure to be used as a printer, a copying machine, facsimile machine, a complex machine or the like.

### <Image Formation System>

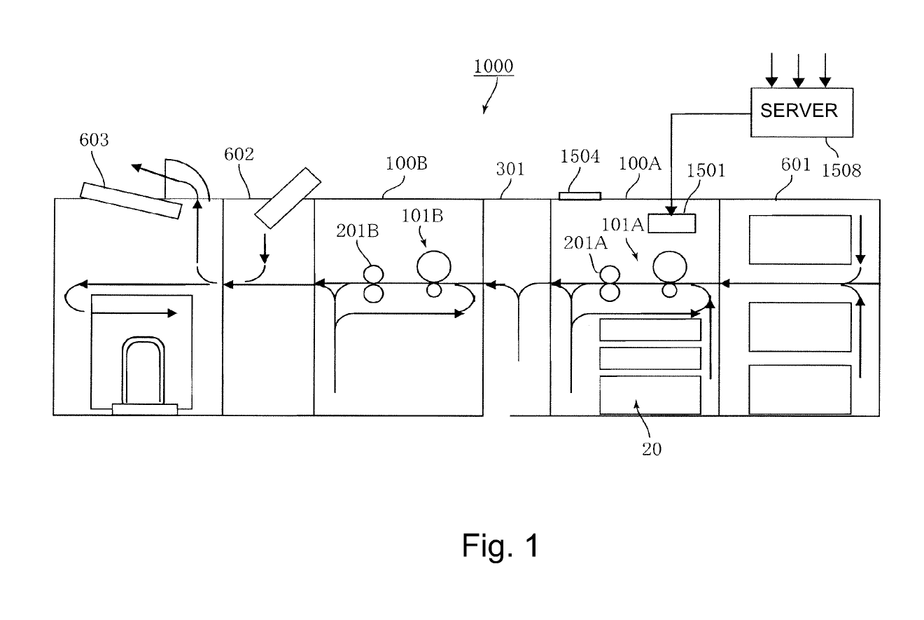

FIG. 1 is a schematic sectional view of the image formation system, and shows the general structure of the system. Referring to FIG. 1, the image formation system 1000 is made up of an image forming apparatus 100A and an image forming apparatus 100B, which are in connection to each other in series. The image forming apparatus 100A is an example of the first image forming section of the image formation system 1000, and the image forming apparatus 100B is an example of the second image forming section of the system 1000. The image formation system 1000 has also a sheet feeder deck 601 of a large capacity, which is an example of a recording medium feeding apparatus. The deck 601 is capable of holding multiple sheets P of recording medium, by the number large enough to continuously feed the image formation system 1000 throughout the night so that the image formation system 1000 can continuously operate whole night in the first mode.

Further, the image formation system 1000 has an inserter 602, and a stacker 603 of a large capacity. In terms of the recording medium conveyance direction, the aforementioned sheet feeder deck 601 is in connection to the upstream end of the image forming apparatus 100A. The inserter 602 and stacker 603 are in connection to the downstream end of the image forming apparatus 100B. That is, the large capacity feeder deck 601, image forming apparatus 100A, image forming apparatus 100B, inserter 602, and stacker 603 are in connection in series in the listed order.

The large capacity sheet feeder deck 601, which is in connection to the upstream end of the image forming apparatus 100A, is such a unit that can store multiple sheets of recording medium by the number greater than the number of sheets of recording medium storable in the recording medium storage section 20 of the image forming apparatus 100A. The recording medium storage section 20 of the image forming apparatus 100A is structured so that it can hold in stack two recording medium cassettes 2 capable of holding a single package of cut sheets of recording medium, and a single recording medium cassette capable of holding two packages of cut sheets of recording medium. That is, assuming here that a single package of sheets of recording medium contains 500 sheets of recording medium of size A3 which are 80 g/m², the recording medium storage section 20 of the image forming apparatus 100A is capable of holding a total of 2,000 sheets of recording medium. In comparison, the large capacity sheet feeder deck 601 is capable of holding in stack three recording medium cassettes, each of which can hold 2,000 sheets of recording medium. Thus, the deck 601 is capable of holding a total of 6,000 sheets of recording medium, and continuously feeding the image formation system 1000 with 6,000 sheets of recording medium.

The large capacity stacker 603 is structured so that a large number of prints can be stacked in the stacker 603 as the prints are discharged from the image forming apparatus 100B. Incidentally, as the prints are discharged from the image forming apparatus 100B, they are stacked in the stacker 603 in the order in which they are discharged from the image forming apparatus 100B. Further, in order to make it easier for the prints to be conveyed further to be subjected to the next process, such as cutting, the stacker 603 is mounted on a wheeled cart. Further, the stacker 603 is provided with a test print tray in addition to the main tray. The test print tray is where the prints made to test the image formation system 1000 are stacked. It is a part of the top surface of the stacker 603.

The capacity of the large capacity stacker 603 is 6,000 sheets of recording medium of size A3, which is equivalent to the capacity of the aforementioned large capacity recording medium feeder deck 601. Thus, by providing the image formation system 1000 with the same number of large capacity stackers 603 as the number of large capacity recording medium feeder decks 601 with which the image formation system 1000 is provided, it is possible to continuously operate the image formation system 1000, without running out of print stacking space, until all the sheets of recording medium in the decks 601 are used up.

The inserter 602 is a unit that is to be used when it is necessary to insert a print or prints among the prints which are being outputted by the image formation system 1000. For example, it is to be used when it is necessary to insert a full-color print, or full-color prints, into a specific place or places among the monochromatic prints which are being outputted by the image formation system 1000. Thus, it is used as necessary.

Incidentally, FIG. 1 shows only one large capacity sheet feeder deck 601, which is on the upstream side of the image forming apparatus 100A in terms of the recording medium conveyance direction. However, two or more large capacity sheet feeder cassettes 601 may be connected in series to the upstream side of the deck 601 in the drawing, so that even a greater number of sheets of recording medium can be continuously fed. This is also true with the large capacity stacker 603 for storing in stack the prints as the prints are discharged from the image forming apparatus 100B. That is, FIG. 1 shows only one large capacity stacker 603. However, two or more large capacity stackers 603 may be connected in series to the stack 603 shown in FIG. 1.

The image forming apparatuses 100A and 100B are 300 mm/sec in process speed. The image formation system 1000 is capable of outputting 2,100 two-sided prints of A3 size an hour. Thus, in a case where the image formation system 1000 is in connection to a single large capacity sheet feeder deck 601 and a single large capacity stacker 603, the image formation system 1000 can continuously output images for three hours without restocking the deck 601 with recording medium and without clearing the stacker 603. In a case where four large capacity recording medium feeder decks 601 are in connection in series, along with four large capacity stackers 603, with the image formation system 1000, the image formation system 1000 can continuously output images no less than 11 hours without restocking the deck with recording medium and clearing the stacker 603.

Further, the image formation system 1000, which is provided with two image forming apparatuses 100A and 100B, is also provided with a relay unit 301 which is placed between the image forming apparatuses 100A and 100B to relay a sheet P of recording medium from the apparatus 100A to the apparatus 100B. The system 1000 is provided two image forming apparatuses 100A and 100B, each of which has its own charging, developing, transferring, and fixing devices. Thus, the system 1000 can form an image on one (first) of the two surfaces of a sheet P of recording medium with the use of the image forming apparatus 100A, turning over the sheet P of recording medium, and form an image on the other (second) surface of the sheet P with the use of the image forming apparatus 100B. Thus, the speed at which the image formation system 1000 can output two-sided prints per preset length of time is twice that of a conventional image forming apparatus.

As described above, the image formation system 1000 has the image forming apparatuses 100A and 100B and relay unit 301. Further, the image forming apparatuses 100A and 100B are the same in structure and are capable of forming an image on their own. Further, the image forming apparatuses 100A and 100B are in connection to each other in series, with the presence of the relay unit 301 between them. Thus, the image formation system 1000 can be easily produced; it can be produced without designing complicated hardware for the production of the image formation system 1000.

An image formation system, such as the image formation system 1000, which has two image forming apparatuses connected in series, can be connected to a large capacity sheet feeding deck, a post-treatment apparatus, etc., which are to be positioned upstream and downstream, respectively, of the two image forming apparatuses 100A and 100B. That is, the peripheral apparatuses, such as the sheet feeding deck, post-treatment apparatus, etc., which can be standardized so that they can be connected in series to the image formation system. Therefore, an image formation system like the image formation system 1000 has merit in that it is significantly smaller in the amount of space it requires, and significantly smaller in cost, than an image formation system which does not employ multiple (two) image forming apparatuses, which are the same in structure and are complete image forming apparatuses on their own.

As an image formation system having multiple (two) virtually identical image forming apparatuses connected in series, the system disclosed in Japanese Laid-open Patent Application H06-343125 can also be listed. This image formation system which is capable of operating in a two-sided image formation mode is provided with two image forming apparatuses which are serially connected to each other, with the presence of a sheet turning unit between the two image forming apparatuses, so that one of the image forming apparatus forms an image on one of the two surfaces of a sheet of recording medium, and the other image forming apparatus forms an image on the other surface of the sheet of recording medium.

### <Image Forming Apparatus>

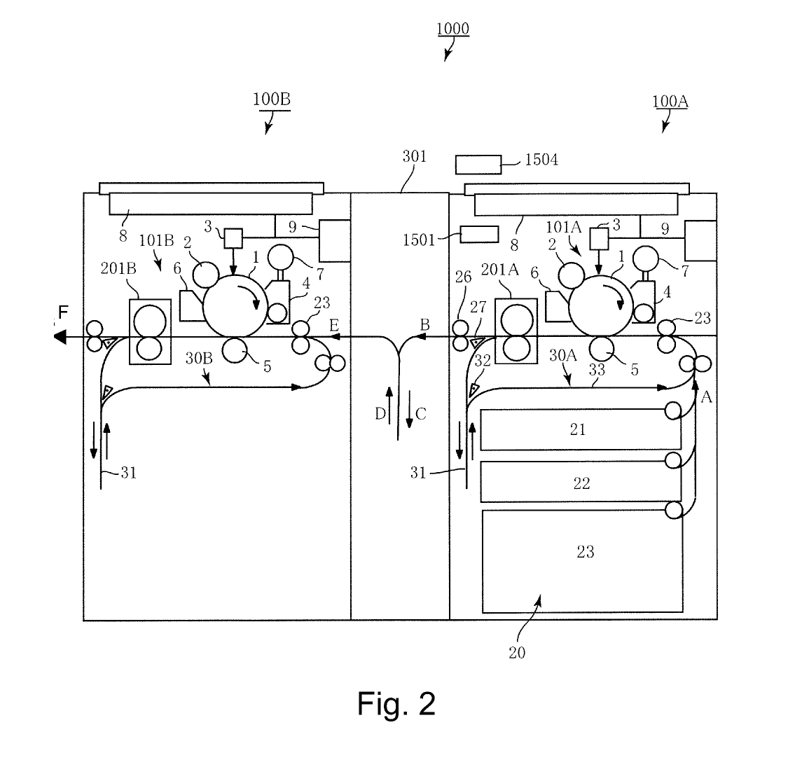

FIG. 2 is a schematic sectional view of a typical image formation system having two virtually identical image forming apparatuses. It shows the general structure of the system. Referring to FIG. 2, a toner image formation station 101A, which is an example of the first toner image formation station, forms a toner image, and transfers the toner image onto a sheet of recording medium. The fixing device 201A, which is an example of the first image heating station, heats the toner image on the sheet of recording medium. The toner image formation station 101B, which is an example of the second toner image formation station, forms a toner image, and transfers the toner image onto the sheet of recording medium which it received from the fixing device 201A. A fixing device 201B, which is an example of the second image heating station, heats the toner formed on the sheet of recording medium in the toner image formation station 101B. A sheet reversing/conveying mechanism 30A turns over the sheet P of recording medium as the sheet P of recording medium is handed over to the mechanism 30A after a toner image was formed on one of the two surfaces of the sheet P by the toner image formation station 101A and was fixed by the fixing device 201a. Then, it sends the sheet P back into the toner image formation station 101A.

The two image forming apparatuses 100A and 100B which are virtually the same in specification are connected in series, with the presence of a relay unit 301, making up the image formation system 1000 having two image forming apparatuses. That is, the upstream image forming apparatus 100A, in terms of the overall direction in which recording medium is conveyed, is serially connected to the downstream image forming apparatus 100B by the relay unit 301, making up an image formation system 1000 which functions as a single image forming apparatus. The image forming apparatuses 100A and 100B can independently operate as an image forming apparatus capable of operating in the two-sided image formation mode. Not only can an image formation system such as the one shown in FIG. 2 be used as an ordinary image forming apparatus, but also, a duplex image forming apparatus. Yet, all you have to design for this system is to design an image forming apparatus of one type. Thus, this system is meritorious.

Although the recording medium storage section of the image forming apparatus 100B is not shown in FIG. 2, the image forming apparatuses 100A and 100B are virtually the same in structure. Thus, in the following description of the image formation system 1000, the structure and operation of only the image forming apparatus 100A will be described to avoid the repetition of the same descriptions (description of image forming apparatus 100B).

The image forming apparatus 100A stores multiple sheets of recording medium in its recording medium storage section 20. It takes the sheets one by one, and transfers the toner image which it forms in its toner image formation station 101A (which is example of first image formation station), onto the sheet of recording medium, in its transfer station T. After the transfer of the toner image onto the sheet P of recording medium, the sheet P and the toner image thereon are subjected to heat and pressure by the fixing device 201A which is an example of the first image heating station of the image formation system 1000. As a result, the toner image becomes fixed to the surface of the sheet P.

When the image forming apparatus 100A is in the one-sided printing mode, a sheet P of recording medium is discharged from the image forming apparatus 100A through the interface of the pair of discharge rollers 26, after the fixation of the toner image to the sheet P. However, when the image forming apparatus 100A is in the two-sided printing mode, a flapper 27 is switched in position so that after the fixation of the toner image to the sheet P, the sheet P is sent into the sheet turning/conveying mechanism 30A. Then, a flapper 32 is operated to convey the sheet P into the recoding medium conveying vertical passage 31. Then, the sheet P is changed in its conveyance direction, and is sent into the recording medium passage 33 for forming an image on the back surface (second surface) of the sheet P. Then, the sheet P is sent again into the transfer station T, remaining turned over. Then, a toner image is transferred onto the back surface (second surface) of the sheet P in the transfer station T, and is fixed to the back surface of the sheet P by the fixing device 201A. After the image formation on both surfaces of the sheet P, the sheet P is discharged from the image forming apparatus 100A through the interface between the pair of discharge rollers 26.

The toner image formation station 101A comprises the photosensitive drum 1, a charge roller 2, an exposing device 3, a developing device 4, a transfer roller 5, and a drum cleaning device 6. The roller 2, exposing device 3, developing device 4, transfer roller 5, and drum cleaning device 6 are in the adjacencies of the peripheral surface of the photosensitive drum 1. The photosensitive drum 1 is made up of an aluminum cylinder, and a photosensitive layer formed on the peripheral surface of the aluminum cylinder. It is rotated in the direction indicated by an arrow mark. The charge roller 2 uniformly charges the peripheral surface of the photosensitive drum 1 to a preset potential level by being provided with a combination of AC and DC voltages.

The exposing device 3 scans the uniformly charged area of the peripheral surface of the photosensitive drum 1 with the beam of laser light it emits; it makes its rotational mirror deflect the beam of laser light it emits, so that the beam of laser light scans the uniformly charged area of the peripheral surface of the photosensitive drum 1. As a given point of the uniformly charged area of the photosensitive layer of the photosensitive drum 1 is exposed to the beam of laser light from the exposing device 3, it reduces in potential. Consequently, an electrostatic image is effected on the peripheral surface of the photosensitive drum 1. When the image forming apparatus 100A is in the copy mode, an original is read by an image reading device 8 (scanner), and the exposing device 3 is controlled according to the information of the original. When the image forming apparatus 100A is in the fax mode, the information of the image to be formed is received by the control section 9 (image receiving section) from a personal computer (unshown), or an external device which is in connection to the image forming apparatus 100A through a telephone line or the like. Then, the exposing device 3 is controlled in response to the received information of the image to be formed. The developing device 4 develops the electrostatic image on the photosensitive drum 1 into a visible image formed of toner, by making charged magnetic toner (single-component developer), borne on the peripheral surface of its development sleeve; it forms a visible image, that is, an image formed of toner, on the peripheral surface of the photosensitive drum 1.

As the toner in the developing device 4 is consumed for image formation, the developing device 4 is replenished with toner by a toner supply bottle 7 to compensate for the toner consumption. To the transfer roller 5, DC voltage, which is opposite in polarity to the toner charge, is applied. As the DC voltage is applied to the transfer roller 5, the transfer roller 5 transfers the toner image on the photosensitive drum 1, onto a sheet P of recording medium, while the sheet P is conveyed, remaining pinched by the transfer roller 5 and photosensitive drum 1, through the transfer station T. The drum cleaning device 6 recovers the transfer residual toner, that is, the toner which escaped from being transferred onto the sheet P from the peripheral surface of the photosensitive drum 1, remaining therefore on the peripheral surface of the photosensitive drum 1 after the transfer.

### <Fixing Device>

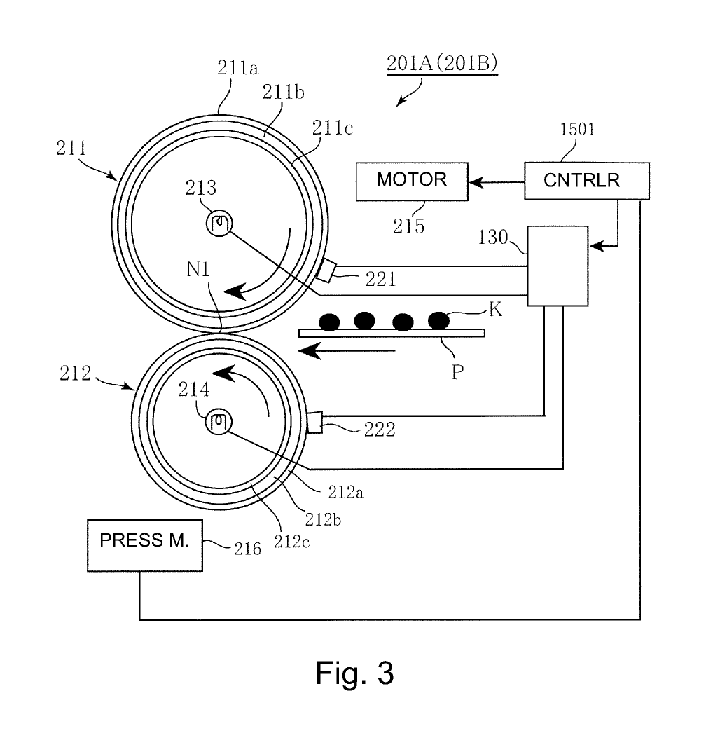

FIG. 3 is a schematic sectional view of the fixing device 201A. It shows the general structure of the device 201A. Referring to FIG. 2, both the fixing device 201A of the image forming apparatus 100A, and the fixing device 201B of the image forming apparatus 100B, are of the so-called heat roller type, and are the same in structure. In other words, the description of the fixing device 201B is the same as that of the fixing device 201A. Thus, only the fixing device 201A will be described to avoid repeating the same description.

Referring to FIG. 3, the fixing device 201A has a fixation roller 211 and a pressure roller 212. The pressure roller 212 has a heat source in its hollow. After the formation of a toner image on a sheet P of recording medium, the fixing device 201A conveys the sheet P between the fixation roller 211 and pressure roller 212 while keeping the fixation roller 211 in contact with the image bearing surface of the sheet P and pressing the pressure roller 212 against the fixation roller 211. Thus, the toner image on the sheet P becomes fixed to the sheet P. The fixing device 201A is made up of the fixation roller 211 and pressure roller 212 which are pressed against each other. The fixation roller 211 is rotated in the direction indicated by an arrow mark R5 by a fixation roller driving motor 215 through the gear train attached to one of the lengthwise ends of the shaft of the fixation roller 211. It is rotated at a peripheral velocity of 300 mm/sec, which is the same as the process speed of the image forming apparatus 100A.

The pressure roller 212 is pressed against the fixation roller 211 by a pressure applying mechanism 216 which applies pressure to the lengthwise ends of the shaft of the pressure roller 212. As the pressure roller 212 is pressed against the fixation roller 211, it forms a fixation nip N1 between its peripheral surface and the peripheral surface of the fixation roller 211. The fixation nip N1 is roughly 10 mm wide in terms of the circumferential direction of the pressure roller 212. The pressure roller 212 is rotated by the rotation of the fixation roller 211 in the direction indicated by an arrow mark.

The fixation roller 211 is made up of a cylindrical metallic core 211c and an elastic layer 211b. The metallic core 211c is made of aluminum, and is 74 mm in external diameter, 6 mm in thickness, and 350 mm in length. The elastic layer 211b is formed on the peripheral surface of the metallic core 211c. It is made of heat resistant silicone rubber (15 degrees in JIS Hardness Scale A). The fixation roller 211 is also provided with a parting layer 211a for making it easier for the fixation roller 211 to separate from toner. The parting layer 211a covers the peripheral surface of the elastic layer 211b. It is made of heat resistant fluorinated resin (PFA tube: perfluoroalkoxyl resin), and is 100 μm in thickness.

Further, the fixing device 201A is provided with a halogen heater 213, which is in the hollow of the fixation roller 211 and is 1,500 W in rated power. The fixing device 201A is also provided with a thermistor 221, which is placed in contact with the peripheral surface of the fixation roller 211 to detect the surface temperature of the recording medium passage portion of the fixation roller 211. A temperature control section 130 turns on or off the halogen heater 213, based on the output (temperature of recording medium passage portion of fixation roller 211) of the thermistor 211, so that the surface temperature of the fixation roller 211 remains at a preset target level (200° C.).

The pressure roller 212 is made up of a cylindrical metallic core 212c and an elastic layer 212b. The metallic core 212c is made of aluminum, and is 54 mm in external diameter, 3 mm in thickness, and 350 mm in length. The elastic layer 212b is formed on the peripheral surface of the metallic core 212c. It is made of heat resistant silicone rubber (20 degrees in JIS Hardness Scale A). The pressure roller 212 is also provided with a parting layer 212a for making it easier for the pressure roller 212 to separate from toner. The parting layer 212a covers the peripheral surface of the elastic layer 212b. It is made of heat resistant fluorinated resin (PFA tube), and is 100 μm in thickness.

Further, the fixing device 201A is also provided with a halogen heater 214, which is in the hollow of the pressure roller 212 and is 400 W in rated power. The fixing device 201A is also provided with a thermistor 222, which is placed in contact with the peripheral surface of the pressure roller 212 to detect the surface temperature of the pressure roller 212. The temperature control section 130 turns on or off the halogen heater 214, based on the output (temperature of recording medium passage portion of pressure roller 212) of the thermistor 222, so that the surface temperature of the pressure roller 212 remains at a preset target level (150° C.)

A fixing device of the so-called heat roller type, which employs a fixing roller having an elastic layer, can uniformly melt the surface of the image on a sheet P of recording medium. Thus, it can enable an image forming apparatus to output a high quality full-color image, more specifically, a full-color image which is uniform in gloss. Thus, it is employed by a wide range of full-color image forming apparatuses. Further, it can also enable a black-and-white image forming apparatus to output a high quality black-and-white image which is uniform in gloss, in particular, when forming a solid black-and-white image.

However, from the standpoint of cost and durability, many of the fixation rollers for a black-and-white image forming apparatus are not provided with the elastic layer; it is made up of a metallic core, and a parting layer which covers the peripheral surface of the metallic core. However, a fixation roller having no elastic layer is likely to fail to uniformly contact a toner image at a microscopic level. Thus, it is likely to make the surface of the toner image nonuniform at a microscopic level, making it difficult for an image forming apparatus to output an image which is satisfactorily uniform in gloss.

### <Relay Unit>

Referring to FIG. 1, as a sheet P of recording medium is discharged from the image forming apparatus 100A of the image formation system 1000 in the first embodiment, the system 1000 turns over the sheet P with the use of the relay unit 301, which turns over the sheet P by changing the sheet P in moving direction. Then, it sends the sheet P into the image forming apparatus 100B.

The speed at which a sheet P of recording medium is conveyed through the image forming apparatus 100A is 300 mm/sec. It takes a certain amount of time for the relay unit 301 to change the sheet P in moving direction. Thus, the relay unit 301 is made faster in the recording medium conveyance speed to minimize the amount of reduction in productivity attributable to the changing of the sheet P in moving direction. More specifically, the recording medium conveyance speed is changed at the entrance of the relay unit 301 from 300 mm/sec to 1,000 mm/sec. Then, it is reduced at the exit of the relay unit 301 from 1,000 mm/sec to 300 mm/sec.

<Toner Image Formation Stations and Relay Unit Different from Preceding Ones>

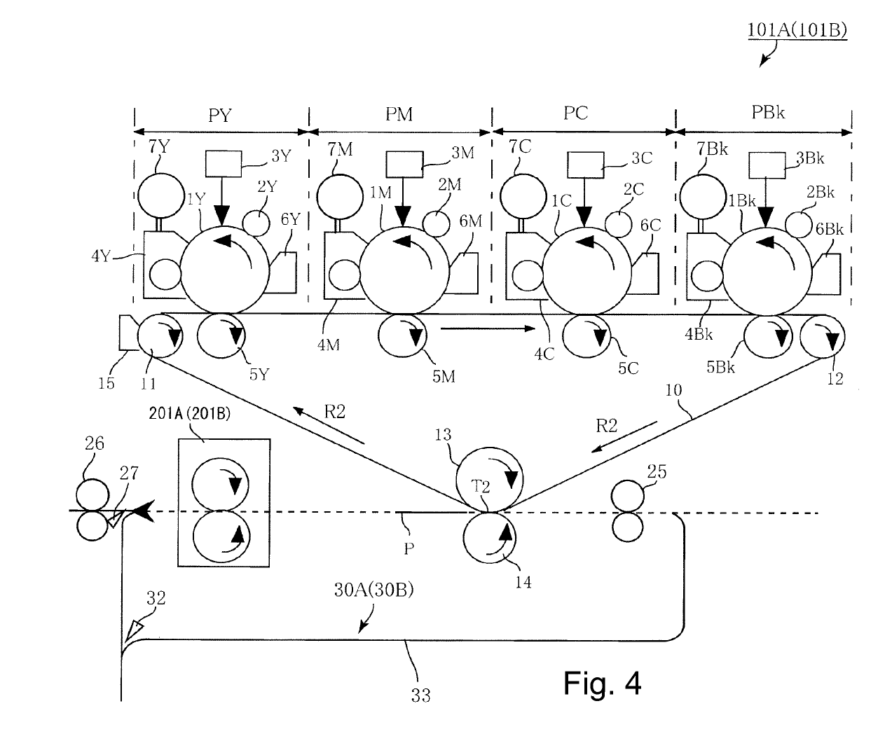

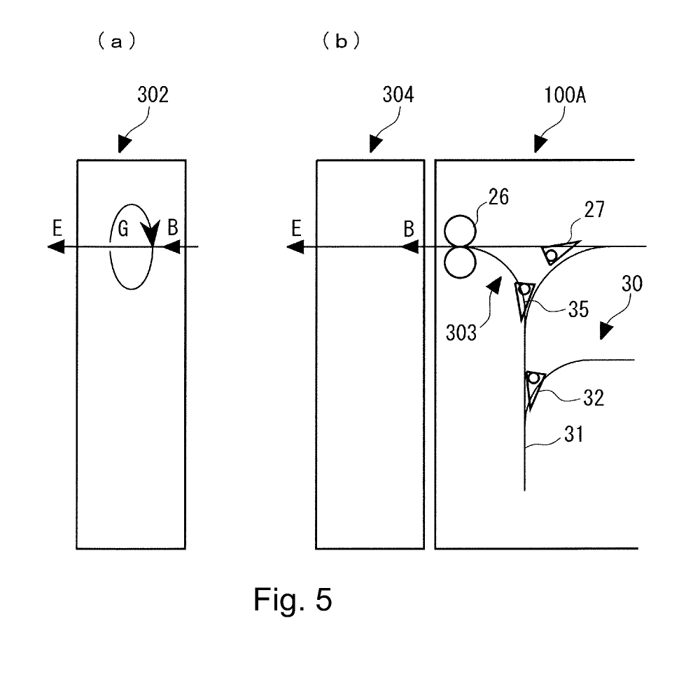

FIG. 4 is a schematic sectional view of a full-color toner image forming apparatus, and shows the general structure of the apparatus. FIG. 5 is a schematic sectional view of a relay unit which is different from the preceding one. It shows the general structure of the unit.

Referring to FIG. 4, the toner image formation stations 101A and 101B of the image forming apparatuses 100A and 100B, respectively, shown in FIG. 2, were replaced with a pair of full-color image formation sections 101A (and 100B). The full-color image formation stations 101A and 101B are virtually the same in structure and operation. Thus, the structure and operation of only the full-color image formation stations 101A will be described to avoid the repetition of the same description.

Referring to FIG. 4, the toner image formation section 101A is of the so-called tandem type, and employs an intermediary transfer belt 10. It has yellow, magenta, cyan, and black toner image formation stations PY, PM, PC and PK, which are aligned in tandem along the intermediary transfer belt 10. The intermediary transfer belt 10 is supported and tensioned by three rollers, that is, a belt driving roller 12, a tension roller 11, and a counter roller 13 which backs up the intermediary transfer belt 10 against a secondary transfer roller 14. The intermediary transfer belt 10 circularly rotates in the direction indicated by an arrow mark R2 by being driven by the belt driving roller 12. In the toner image formation station PY, a yellow toner image is formed, and is transferred onto the intermediary transfer belt 10. In the toner image formation station PM, a magenta toner image is formed and is transferred onto the intermediary transfer belt 10. In the toner image formation stations PC and PK, cyan and black toner images, respectively, are formed and are transferred onto the intermediary transfer belt 10.

After the transfer of the four monochromatic toner images, different in color, onto the intermediary transfer belt 10, the toner images are conveyed to the secondary transfer station T2, and are transferred (secondary transfer) onto a sheet P of recording medium, in the secondary transfer station T2. There are multiple sheets P of recording medium stored in a recording medium storing section (20 in FIG. 1). The sheets P are conveyed one by one to a pair of registration rollers 23, and are kept on standby by the registration rollers 23. Then, each sheet P of recording medium is sent to the secondary transfer station T2 by the registration rollers 23 with such timing that the sheet P arrives at the same time as the toner images on the intermediary transfer belt 10. Then, the sheet P is conveyed through the second transfer station T2 while remaining pinched by the intermediary transfer belt 10 and transfer roller 14. While the sheet P is conveyed through the second transfer station T2, the toner images on the intermediary transfer belt 10 are transferred onto the sheet P. Then, the sheet P and the toner images thereon are subjected to heat and pressure by the fixing device 201A, whereby the toner images are fixed to the surface of the sheet P. The toner particles which escaped from being transferred onto the sheet P, and therefore, are remaining adhered to the intermediary transfer belt 10, are recovered by the belt cleaning device 15.

In the one-side printing mode, the sheet P of recording medium is discharged from the image forming apparatus 100A through the interface between the pair of discharge rollers 26, after the fixation of the toner images to the sheet P. In the two-side printing mode, however, a flapper 27 is switched in position so that after the fixation of the toner images to the sheet P, the sheet P is sent into a vertical sheet conveyance passage 31. Then, a flapper 32 is operated to change the sheet P in conveyance direction to turn over the sheet P and send the sheet into a recording medium passage 33 for forming an image on the back surface (second surface) of the sheet P. Then, the sheet P is sent again into the secondary transfer station T2 to transfer an image onto the back surface (second surface) of the sheet P, and fix it to the back surface of the sheet P by the fixing device 201A. After the image formation on both surfaces of the sheet P, the sheet P is discharged from the image forming apparatus 100A through the interface between the pair of discharge rollers 26.

The toner image formation stations PY, PM, PC and PK are virtually the same in structure, although they are different in the color of the toners which the developing devices 4Y, 4M, 4C and 4K use. Thus, only the toner image formation station PY will be described. The descriptions of the toner image formation stations PM, PC and PK, one for one, are the same as that of the toner image formation station PY, except for the suffixes M, C and K of the referential codes of their structural components and the like, which replace the suffix Y of those of the structural components and the like of the image formation station PY.

The toner image formation station PY comprises the photosensitive drum 1Y, a charge roller 2Y, an exposing device 3Y, a developing device 4Y, a transfer roller 5Y, and a drum cleaning device 6Y. The charge roller 2Y, exposing device 3Y, developing device 4Y, transfer roller 5Y, and drum cleaning device 6Y are in the adjacencies of the peripheral surface of the photosensitive drum 1Y. The photosensitive drum 1Y is made up of an aluminum cylinder, and a photosensitive layer formed on the peripheral surface of the aluminum cylinder. It is rotated in the direction indicated by an arrow mark. The charge roller 2Y uniformly charges the peripheral surface of the photosensitive drum 1Y to a preset potential level by being provided with a combination of AC and DC voltages. The exposing device 3Y scans the uniformly charged area of the peripheral surface of the photosensitive drum 1Y, with the beam of laser light it emits; it makes its rotational mirror deflect the beam of laser light it emits, so that the beam of laser light scans the uniformly charged area of the peripheral surface of the photosensitive drum 1Y. As a given point of the uniformly charged area of the photosensitive layer of the photosensitive drum 1Y is exposed to the beam of laser light from the exposing device 3Y, it reduces in potential. Consequently, an electrostatic image is effected on the peripheral surface of the photosensitive drum 1Y. When the image forming apparatus 100A is in the copy mode, an original is read by an image reading device (8 in FIG. 2), and the exposing device 3Y is controlled according to the information of the original. When the image forming apparatus 100A is in the fax mode or print mode, the information of the image to be formed is received by the data processing section (9 in FIG. 2) (image receiving section) from a personal computer (unshown), or an external device which is in connection to the image forming apparatus 100A through a telephone line or the like. Then, the exposing device 3Y is controlled in response to the received information of the image to be formed. The developing device 4Y develops the electrostatic image on the photosensitive drum 1Y into a visible image formed of toner, by making the peripheral surface of its development sleeve bear charged two-component developer, that is, a mixture of magnetic carrier and nonmagnetic toner; it forms a visible image, that is, an image formed of toner, on the peripheral surface of the photosensitive drum 1Y.

As the toner in the developing device 4Y is consumed for image formation, the developing device 4Y is supplied with toner by a toner supply bottle 7Y to compensate for the toner consumption. To the transfer roller 5Y, DC voltage which is opposite in polarity to the toner charge is applied. As the DC voltage is applied to the transfer roller 5Y, the transfer roller 5Y transfers the toner image on the photosensitive drum 1Y, onto the intermediary transfer belt 10, which is being moved between the peripheral surface of the photosensitive drum 1Y and transfer roller 5Y, remaining pinched by the transfer roller 5 and photosensitive drum 1Y, through the transfer station T. The drum cleaning device 6Y recovers the transfer residual toner, that is, the toner which escaped from being transferred onto the intermediary transfer belt 10 from the peripheral surface of the photosensitive drum 1Y, being therefore remaining on the peripheral surface of the photosensitive drum 1Y after the transfer.

Referring to FIG. 5(a), the relay unit 301 may be replaced with a relay unit 302, which uses a sheet turning method other than the sheet turning method which turns over a sheet of recording medium by changing the sheet in conveyance direction. The relay unit 302 rotates rightward or leftward a sheet P of recording medium about the centerline of the sheet in terms of the direction perpendicular to the sheet conveyance direction, without changing the sheet P in conveyance direction. That is, the relay unit 302 turns over the sheet P by spirally moving the sheet P so that the leading edge of the first surface of the sheet P becomes the leading edge of the second surface of the sheet P. Then, it delivers the sheet P to the image forming apparatus 100B through a sheet passage E. The relay unit 302 can precisely align the print start line on the first surface of the sheet P with the print start line on the second surface of the sheet P. Therefore, it is advantageous over the relay unit 301 when it is required to precisely align the print start line on the first surface of the sheet P with the print start line on the second surface of the sheet P.

Next, referring to FIG. 5(b), instead of the provision of the relay unit (301), the image forming apparatus 100A may be provided with a mechanism 303 which outputs a print in such an attitude that the image bearing surface of the sheet P faces downward. The mechanism 303 changes the sheet P in conveyance direction by sending the sheet P into the vertical sheet passage 31, on the downstream side of the fixing device 201A of the image forming apparatus 100A. Then, it sends the sheet P to the relay unit 304 through a sheet passage B. In this case, the relay unit 304 does not need to be provided with the sheet turning function; all that is required of the relay unit 304 is to have the function of conveying the sheet P from the image forming apparatus 100A to the image forming apparatus 100B.

### <Control Section and Control Panel>

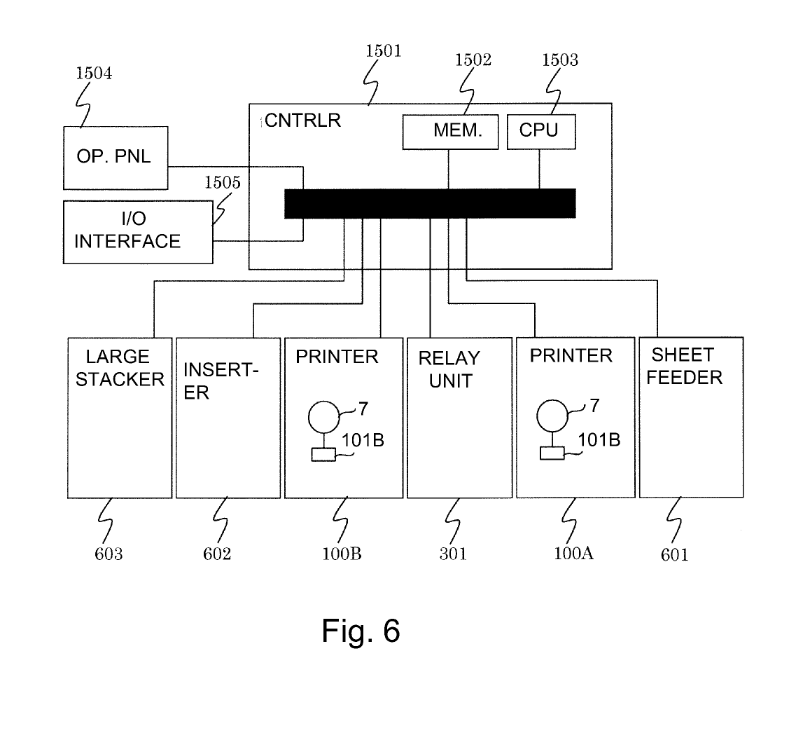

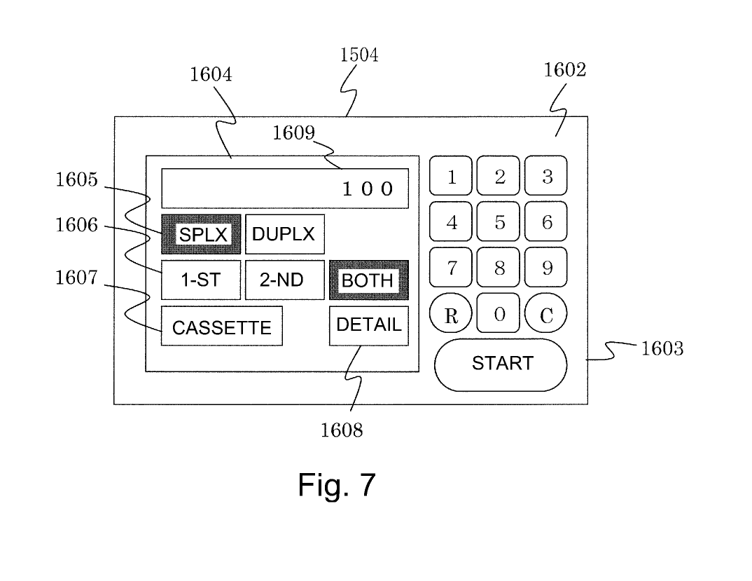

FIG. 6 is a block diagram of the control system of the image formation system 1000. FIG. 7 is a plan view of the control panel of the image formation system 1000. Referring to FIG. 6, an operator can operate the image formation system 1000 by inputting various settings and operational instructions into the control section 1501 of the image forming apparatus 100A, that is, the upstream image forming apparatus, with the use of the control panel 1504 of the image forming apparatus 100A. It is the control section 1501 of the image forming apparatus 100A that makes the various basic structural units of the image formation system 1000 operate in coordination. Here, the operation of the image formation system 1000, which is controlled with the use of the control panel 1504, is described. In certain situations, however, printing commands are given to the image formation system 1000 from an external computer through an input interface 1505.

Referring to FIG. 6, the image forming apparatus 100A, relay unit 301, image forming apparatus 100B, inserter 602, and large capacity stacker 301, which are the basic structural units of the image formation system 1000, are integrally controlled by the commands issued by the control section 1501, which is in connection to the control panel 1504 and input/output interface 1505. The basic structural units, control panel 1504, input/output interface 1505 are in connection to the storage section 1502 and CPU 1503 by way of the internal buses of the control section 1501.

The control panel 1504 is a part of the top panel of the image forming apparatus 100A. The input/output interface 1505 is made up of LAN (local area net work), cable connector jacks, etc. It is the section through which the printing job instructions are inputted into the control section 1501 from an external host computer, a workstation, etc., through the network. In a case where the printing commands are issued from an external computer through the input/output interface 1505, a print menu, which has icons for choosing the following settings, so that an operator can select the item, with the use of the printing menu.

Next, referring to FIG. 7, the control panel 1504 has various keys such as ten keys for inputting numerical values. It is used by a user or an operator to input the number by which prints are to be outputted, and also, to input printing operation commands. The ten keys 1602 are for inputting the number by which prints are to be made. The control panel 1504 is also provided with a key C and a key R. The key C is for cancelling the input, and is on the right side of a key 0. The key R is a reset key, and is on the left side of the key 0. The control panel 1504 is also provided with a start key 1603, which is for inputting a print start command. As the start key 1603 is pressed, the control section 1501 reads the settings such as the print count and recording medium cassette choice, etc., and starts the printing operation, which will be described later. The liquid crystal touch panel 1604 is a part of a liquid crystal monitor of the so-called touch panel type. Not only does it display information, but also, it can be touched to input information.

A recording medium cassette selection icon 1607 is for choosing the recording medium cassette which contains the sheets of recording medium to be used for the printing operation which is going to be started. As the recording medium cassette selection icon 1607 is touched, an unshown cassette selection menu is displayed, which shows the state of the sheets of recording medium in each of the selectable recording medium cassettes, including the sheet feeder deck (601 in FIG. 1) of the large capacity. Not only can the cassette selection menu be used for cassette selection, but also, it can be used to input various instructions regarding the automatic switching of the recording medium cassette. A detail selection key 1608 is for selecting the details of the basic settings. Touching the detail selection icon 1608 makes the monitor to display a menu (unshown) for allowing a user or an operator to use the display to choose various factors such as image magnification.

An icon 1605 is for instructing the image forming apparatus 100A about whether the image forming apparatus 100A is to be operated in the one-sided printing mode or two-sided printing mode. That is, the icon 1605 is for inputting the instruction about whether an image is to be formed on only one surface, or both surfaces, of a sheet of recording medium. Initially, the icon 1605 is black, indicating that the image forming apparatus 100A is in the one-sided printing mode. If it is necessary to put the image forming apparatus 100A in the two-sided printing mode, a user is to touch the two-sided printing mode icon. As the two-sided printing mode icon is touched, the icon turns white, indicating that the image forming apparatus 100A is in the two-sided printing mode.

An icon 1606 is for selecting the first, second, or third mode when the image forming apparatus 100A is in the two-sided printing mode. Incidentally, in a case where the image forming apparatus 100A is in the two-sided printing mode, and printing commands are inputted with the use of an external device such as a computer, the first, second, or third mode can be selected from the display of the computer. In the first mode, the image formation system 1000 uses both the image forming apparatuses 100A and 100B to carry out an image forming operation under the inputted image formation conditions. In the second mode, the image formation system 1000 uses only the image forming apparatus 100A, that is, without using the image forming apparatus 100B, to carry out an image forming operation under the inputted image formation conditions. In the third mode, the image formation system 1000 uses only the image forming apparatus 100B, that is, without using the image forming apparatus 100A, to carry out an image forming operation under the inputted image formation conditions.

In the first mode, an icon named “both” is highlighted, and a two-sided printing operation is carried out using both the image forming apparatuses 100A and 100B. The initial setting is the first mode, which is the highest mode in productivity. In comparison, in the second mode, an icon named “first” is highlighted, and a two-sided printing operation is carried out using only the image forming apparatus 100A, that is, the upstream image forming apparatus. In the third mode, an icon named “second” is highlighted, and a two-sided printing operation is carried out using only the image forming apparatus 100B, that is, the downstream image forming apparatus.

In the second and third modes, only one of the two image forming apparatuses 100A and 100B is used to form an image on both surfaces of a sheet of recording medium. Therefore, they are half the first mode in terms of the number of print outputs per unit length of time. Also in the second and third modes, the process speed has to be reduced because of the restriction of the recording medium conveyance speed, which is attributable to the recording medium turning/conveying mechanisms 30A and 30B of the image forming apparatuses 100A and 100B, respectively. Also for this reason, therefore, the second and second modes are lower in productivity than the first mode.

However, in the first mode, which uses both the image forming apparatuses 100A and 100B, if one of the two apparatuses 100A and 100B becomes unusable for such a reason that it ran out of toner, the entirety of the image formation system 1000 stops. In comparison, in the second and third modes, even if one of the two apparatuses 100A and 100B becomes unusable for one reason or the other, the on-going image forming operation can be continued with the use of the image forming apparatus which is usable, although the image formation system 1000 becomes half in productivity. That is, the second and third modes has merit in that even if one of the image forming apparatuses 100A and 100B becomes unusable during a two-sided printing operation, the operation can be continued.

### <First Mode>

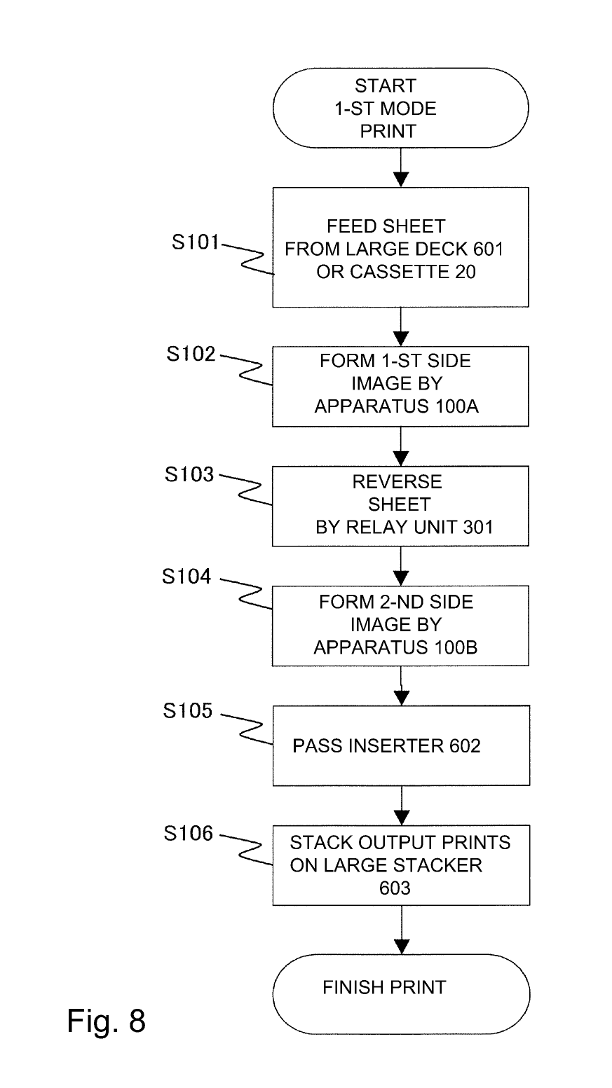

FIG. 8 is a flowchart of the control sequence in the first mode. Referring to FIG. 2, in the first mode, an image is formed on one (front surface) of the two surfaces of a sheet P of recording medium with the use of the image forming apparatus 100A, or the upstream image forming apparatus. Then, the sheet P is turned over by the relay unit 301. Then, an image is formed on the other surface (back surface) of the sheet P with the use of the image forming apparatus 100B, or the downstream image forming apparatus. When the image formation system 1000 is in the default mode, or the first mode, the control section 1501 makes the image formation system 1000 serially use the image forming apparatuses 100A and 100B to form two images on the front and back surfaces, one for one, of the sheet P.

Referring to FIG. 8 along with FIG. 6, it is the sheets P of recording medium in the large capacity sheet feeder deck 601, or recording medium storage section 20 of the image forming apparatus 100A, that begin to be conveyed to the toner image formation station 100A as an image forming operation starts (S101). Then, the control section 1501 transfers a toner image formed by the toner image formation station 101A, onto the sheet P as the sheet P is conveyed through the toner image formation station 101A. Then, the control section 1501 fixes the toner image on the sheet P with the use of the fixing device 201A, ending thereby the image formation on the first surface of the sheet P (S102).

After the formation of an image on the first surface of the sheet P of recording medium, the control section 1501 turns over the sheet P with the use of the relay unit 301, and delivers the sheet P to the image forming apparatus 100B (S103). Then, the control section 1501 forms a toner image in the toner image formation station 101B, and transfers the image onto the second surface of the sheet P. Then, it fixes the toner image on the second surface of the sheet P (S104).

Sometimes, it is necessary to insert, with a preset intervals, a page, or pages, printed by an image forming apparatus (system) other than the image formation system 1000, among the prints being outputted by the image formation system 1000. In such a case, the control section 1501 activates the inserter 602 as necessary (S105). Lastly, the control section 1501 stacks the outputted sheets P in the large capacity stacker 603, ending thereby the image forming operation in the two-side mode (S106).

### <Second Mode>

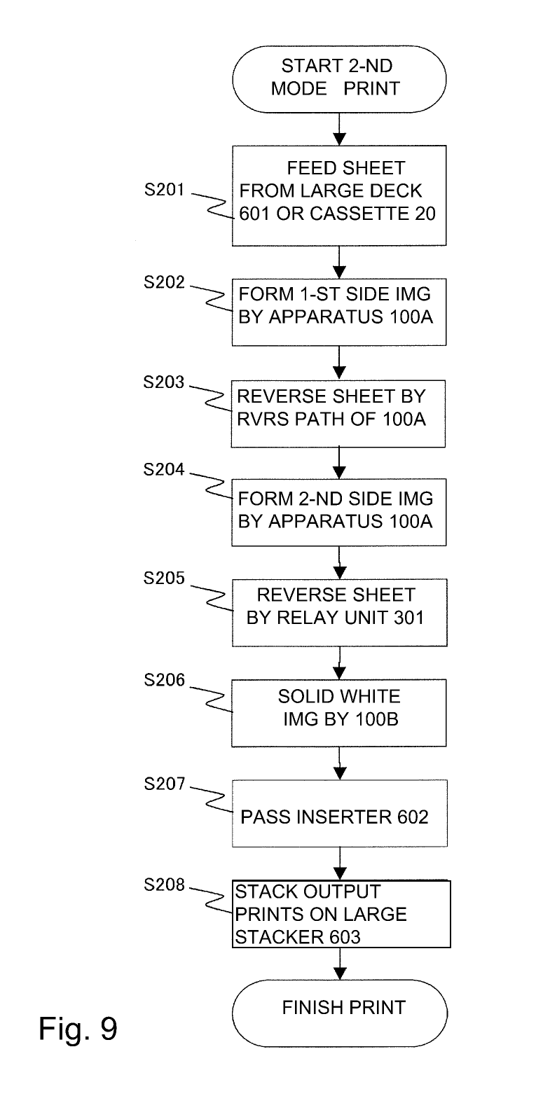

FIG. 9 is a flowchart of the control sequence in the second mode. Referring to FIG. 2, in the second mode, the control section 1501 uses the image forming apparatus 100A, or the upstream image forming apparatus, in the two-sided printing mode to form an image on both the front and back surfaces of a sheet P of recording medium. Then, it uses the relay unit 301 to deliver the sheet P from the image forming apparatus 100A to the image forming apparatus 100B, or the downstream image forming apparatus. Then, it simply conveys the sheet P through the image forming apparatus 100B. That is, when the image formation system 1000 is in the second mode, an image is formed on both surfaces of the sheet P with the use of only the image forming apparatus 100A, or the upstream image forming apparatus. The image forming apparatus 100B is not used at all for image formation; the sheet P is simply put through the image forming apparatus 100B.

Referring to FIG. 9 along with FIG. 6, it is the sheets P of recording medium in the large capacity sheet feeder deck 601, or recording medium storage section 20 of the image forming apparatus 100A, that are conveyed to the toner image formation station 101A, as an image forming operation starts (S201). Then, the control section 1501 transfers a toner image formed by the toner image formation station 101A, onto the sheet P as the sheet P is conveyed through the toner image formation station 101A. Then, the control section 1501 fixes the toner image on the sheet P with the use of the fixing device 201A, ending thereby the image formation on the first surface of the sheet P (S202).

After the formation of an image on the first surface of the sheet P of recording medium, the control section 1501 turns over the sheet P with the use of the sheet turning (reversing) passage 30, and delivers the sheet P to the secondary transfer station of the image forming apparatus 100A for the second time (S203). Then, the control section 1501 forms a toner image in the toner image formation station 101A, and transfers the image onto the second surface of the sheet P. Then, it fixes the toner image on the second surface of the sheet P with the use of the fixing device 201A of the image forming apparatus 100A, ending there by the image formation on the second surface of the sheet P (S204).

Next, the control section 1501 turns over the sheet P having an image on both surfaces, by changing the sheet P in conveyance direction with the use of the relay unit 301, and delivers the sheet P to the image forming apparatus 100B (S205). As the sheet P is introduced into the image forming apparatus 100B, it is put through the image forming apparatus 100B without forming an image on the sheet P. In this case, the control section 1501 sends to the toner image formation station 101B such image formation signals that are for forming a solid white image (colorless image). Thus, the toner image formation station 101B simply outputs a sheet P of recording medium having no image.

When it is necessary to insert, with a preset intervals, a page, or pages, printed by an image forming apparatus (system) other than the image formation system 1000, among the prints being outputted, the control section 1501 activates the inserter 602 as necessary (S207). Lastly, the control section 1501 stacks the outputted sheets P in the large capacity stacker 603, ending thereby the image forming operation in the two-sided printing mode (S208). With the use of the above described control sequence, it is possible to form an image on both surfaces of the sheet P with the use of only the image forming apparatus 100A, or the upstream image forming apparatus.

### <Third Mode>

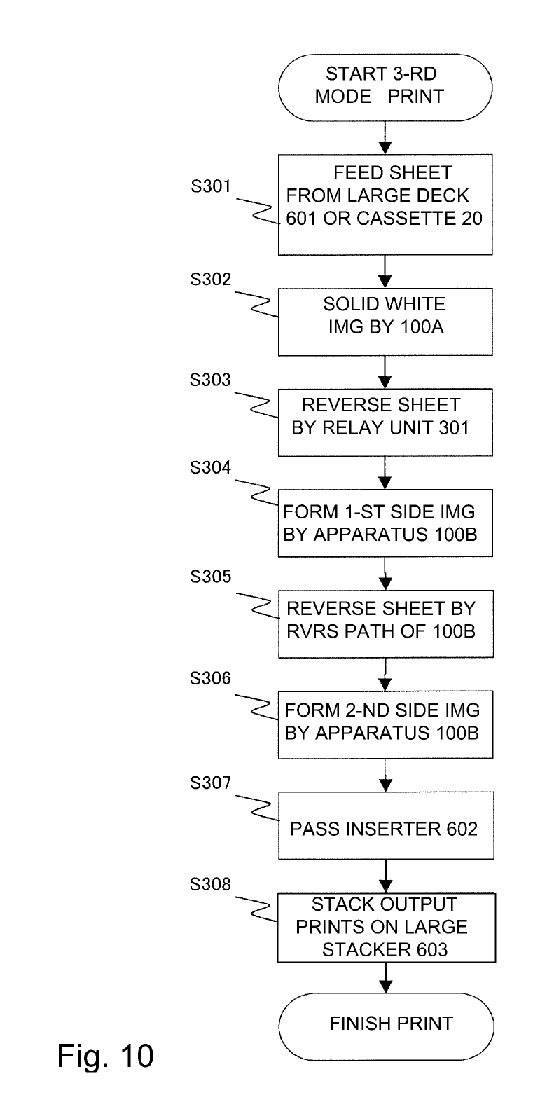

FIG. 10 is a flowchart of the image formation system control sequence in the third mode. Referring to FIG. 2, in the third mode, a sheet P of recording medium is conveyed through the image forming apparatus 100A and relay unit 301 without forming an image on the sheet P, and then, is delivered to the image forming apparatus 100B. Then, the image forming apparatus 100B is operated in the two-sided printing mode to form an image on both surfaces of the sheet P. When the image formation system 1000 is in the third mode, the control section 1501 puts the sheet P through the image forming apparatus 100A without forming an image on the sheet P. Then, it forms an image on both surface of the sheet P with the use of only the image forming apparatus 100B, or the downstream image forming apparatus.

Referring to FIG. 10 along with FIG. 6, it is the sheets P of recording medium in the large capacity sheet feeder deck 601, or recording medium storage section 20 of the image forming apparatus 100A, that are conveyed to the toner image formation station 101A, as an image forming operation starts (S301). Then, as the sheet P is introduced into the image forming apparatus 100A, it is conveyed through the image forming apparatus 100A without the formation of an image on the sheet P. In this case, the control section 1501 sends to the toner image formation station 101A such image formation signals that are for forming a solid white image (colorless image). Thus, the toner image formation station 101A simply outputs a sheet P of recording medium having no image.

Then, the control section 1501 turns over the sheet P by changing the sheet P in conveyance direction with the use of the relay unit 301, and delivers the sheet P to the image forming apparatus 100B (S303). Then, it forms an image with the use of the toner image formation station 101B, and transfers the image onto on the first surface of the sheet P. Then, it fixes the toner image with the use of the fixing device 201B, ending thereby the image formation on the first surface of the sheet P (S304).

Next, the control section 1501 turns over the sheet P by changing the sheet P in conveyance direction with the use of the reversing passage 30 in the image forming apparatus 100B, and sends the sheet P to the secondary transfer station of the image forming apparatus 100B for the second time (S305). Then, the control section 1501 forms an image with the use of the image forming apparatus 100B, and transfers the toner image onto the reversed sheet P. Then, it fixes the toner image with the use of the fixing device 201B in the image forming apparatus 100B, ending thereby the image formation on the second surface of the sheet P (S306).

When it is necessary to insert, with a preset intervals, a page, or pages, printed by an image forming apparatus (system) other than the image formation system 1000, among the prints being outputted, the control section 1501 activates the inserter 602 as necessary (S307). Lastly, the control section 1501 stacks the outputted sheets P in the large capacity stacker 603, ending thereby the image forming operation in the two-side mode (S308). With the use of the above described control sequence, it is possible to form an image on both surfaces of the sheet P with the use of only the image forming apparatus 100B, or the down stream image forming apparatus.

### <Interruption of First Mode>

If one of the image forming apparatuses 100A and 100B of the image formation system 1000 runs out of toner while the image formation system 1000 is in the two-sided printing mode and is continuously operated in the first mode, it becomes impossible for the image formation system 1000 to continue to operate in the two-sided printing mode. Thus, as the image forming apparatus 100A or image forming apparatus 100B shuts down, the entirety of the image formation system 1000 shuts down.

Image formation systems such as the image formation system 1000 are in demand in a POD market such as light-duty printing field in which the main concern is productivity. That is, they are desired to be high in output, and be continuously operatable for a substantial length of time, for example, 24 hours. In other words, it is possible that an operator of the image formation system 1000 will go home after setting the image formation system 1000 so that it will continuously operate for 24 hours. In this case, however, it is possible that one of the two image forming apparatuses of the image formation system 1000 will run out of toner, or suffer from the like problem, late at night when the operator is gone. With one of the two image forming apparatuses of the image formation system 1000 being out of toner, the image formation system 1000 automatically shuts down. In other words, it is possible for the image formation system 1000 to shut down while no one is attending to the system 1000.

In the following preferred embodiments of the present invention, if one of the two image forming apparatuses of the image formation system 1000 runs out of toner, or suffers from the like problem, and therefore, shuts down, while the image formation system 1000 is in the two-sided printing mode and is operated in the first mode, the control section 1501 switches the image formation system 1000 in operational mode from the first mode to the second or third mode so that the two-sided image forming operation can be continued with the use of only the normal image forming apparatus, that is, the one which has not run out of toner, or suffered from the like problem. More concretely, the image forming apparatus having the problem is not used for image formation, and is made to simply convey recording medium. That is, the control section 1501 resets the image formation system 1000 so that the operation for forming an image on both surfaces of a sheet of recording medium is continued with the use of the combination of the normal image forming apparatus, and the sheet reversing/conveying mechanism of the normal image apparatus.

### Embodiment 1

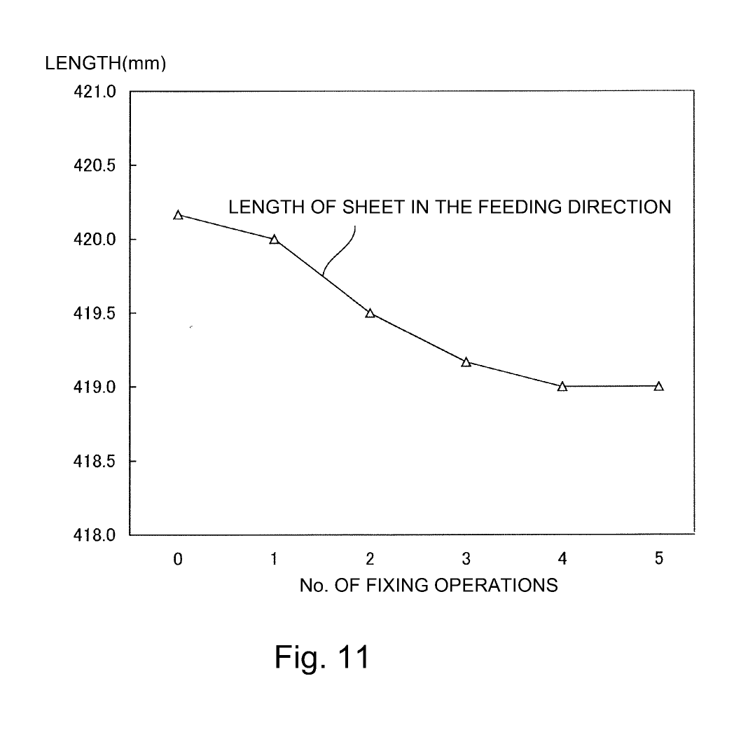

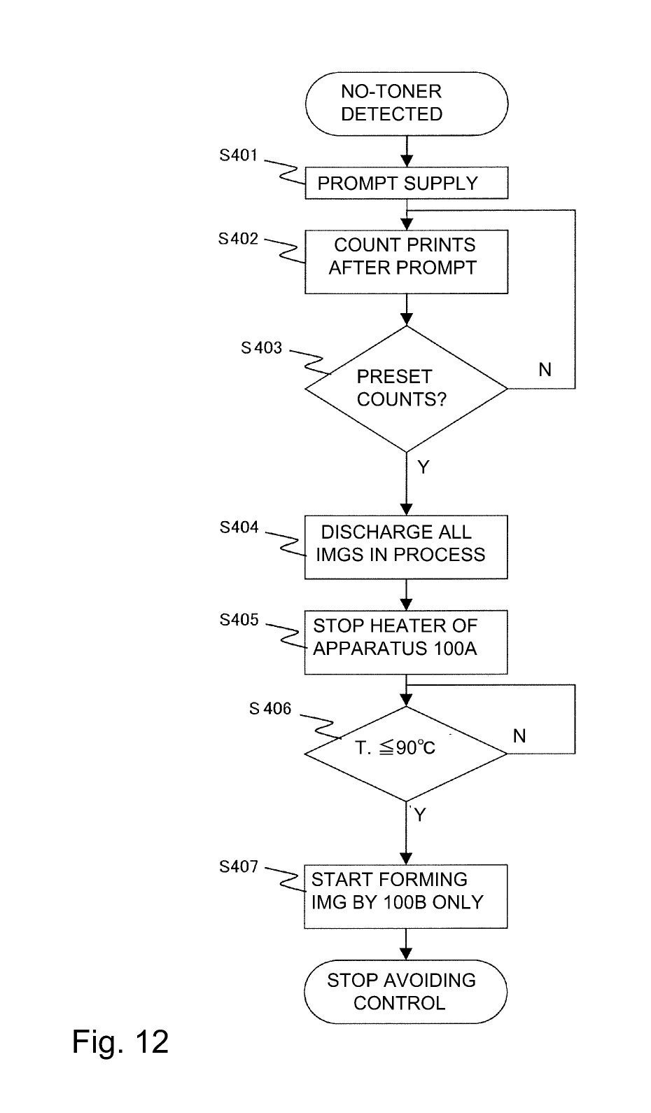

FIG. 11 is a graph which shows the relationship between the number of times each sheet of recording medium is subjected to fixation, and the amount of the sheet shrinkage. FIG. 12 is a flowchart of the stop avoiding control sequence, in the first embodiment, for preventing the image formation system 1000 from shutting down. Referring to FIG. 1, the control section 1501, which is an example of a control section, makes the large capacity sheet feeder deck 601 supply the image formation system 1000 with sheets P of recording medium so that the image formation system 1000 can operate in the first mode for a substantial length of time without being attended by an operator. Further, it is enabled to switch the image formation system 1000 in operational mode from the first mode (default mode) to the second or third mode in response to the changes which occur to the image formation system 1000 after the starting of the image formation system 1000. Further, the control section 1501 sets lower the level to which the temperature of the fixing device 201B is set in the second mode than that in the first mode. It also sets lower the level to which the temperature of the fixation device 201B is set in the third mode than that in the first mode.

Referring to FIG. 12, if an anomaly occurs to the toner image formation station 101B while the image formation system 1000 is operated in the first mode, the control section 1501 reduces in temperature the fixing device 201B after it discharges the sheet P of recording medium, which is between the upstream end of the toner image formation station 101A and the downstream end of the fixing device 201B, through the fixing device 201B. Then, as soon as the temperature of the fixing device 201B reduces to a preset level or below, the control section 1501 starts the image formation system 1000 in the second mode, in which it makes the image formation system 1000 form an image on both surfaces of a sheet P of recording medium with the use of only the image forming apparatus 100A, more specifically, the reversing/conveying mechanism 30A, toner image formation station 101A, and fixing device 201A of the image forming apparatus 100A. Further, in the second mode, the control section 1501 sets the image formation speed of the first toner image formation station to be slower than in the first mode.

In the first embodiment, if one of the image forming apparatuses 100A and 100B shuts down because it has run out of toner, or suffers from the like problem, the control section 1501 automatically carries out the stop avoiding control, that is, a control for switching the image formation system 1000 in operational mode from the default mode (first mode) to the second or third mode. That is, if one of the serially connected two image forming apparatuses 100A and 100B of the image formation system 1000 shuts down its operation because it has run out of toner, or suffers from the like problem, the control section 1501 automatically carries out the stop avoiding control. More specifically, as the control section 1501 detects that one of the two image forming apparatuses is out of toner, it continues to operate the image formation system 1000 in the two-sided printing mode with the use of the other image forming apparatus, that is, the image forming apparatus which is not out of toner. That is, as one of the two image forming apparatuses of the image formation system 1000 becomes inoperable because of such a situation that it has run out of toner, the control section 1501 switches the image formation system 1000 in operational mode so that the image formation system 1000 can be continuously operated in the two-sided printing mode with the use of the other image forming apparatus, that is, the normal image forming apparatus.

As a sheet P of recording medium is fed into the image formation system 1000 from the recording medium feeder deck 601, it is conveyed to the image forming apparatus 100A. If the image forming apparatus 100A, or the upstream image forming apparatus, shuts down, the sheet P is put through the image forming apparatus 100A without the formation of an image on the sheet P. Then, an image is formed on both surfaces of the sheet P with the use of the image forming apparatus 100B, or the downstream image forming apparatus. Then, the sheet P is conveyed to the large capacity stacker 603, which is on the downstream side of the image forming apparatus 100B. In other words, the image forming apparatus 100A, or the upstream image forming apparatus, is used simply as a part of the recording medium conveyance passage between the recording medium feeder deck 601 and image forming apparatus 100B. In comparison, if the downstream image forming apparatus 100A shuts down, an image is formed on both surfaces of the sheet P with the use of only the upstream image forming apparatus 100A. In this case, the downstream image forming apparatus 100B is used as the recording medium conveyance passage between the upstream image forming apparatus 100A, and the large capacity stacker 603, which is on the downstream side of the image forming apparatus 100B.

However, carrying out the above-described stop avoiding control sequence creates the following problem. That is, before the starting of the above described stop avoiding control, each sheet P of recording medium was put through a fixing device only twice. However, as the shutdown control begins, each sheet P of recording medium is put through the fixation process three times. Consequently, the sheet P is changed in dimension by the fixation, which in turn changes the positional relationship between the sheet P and onto where on the sheet P an image is transferred.

FIG. 11 shows the relationship between the length (in terms of recording medium conveyance direction) of a sheet P of ordinary recording medium, more specifically, a sheet of ordinary paper, which is 80 g/cm² in basis weight, and the number of times the sheet P was put through the fixation process. As is evident from FIG. 11, as the sheet P is subjected to the fixation process, the moisture in the sheet P is made to evaporate by the heat from the fixation. As a result, the sheet P reduces in the length in terms of the recording medium conveyance direction. In other words, the greater the number of times the sheet P was subjected to the fixation process, the greater the amount of shrinkage of the sheet P in terms of the recording medium conveyance direction. More specifically, a print formed under the normal control in which the sheet P is subjected to the fixation process only twice is roughly 200 μm shorter longer than a print formed under the stop avoiding control in which the sheet P is subjected to the fixation process three times. This amount by which a sheet P of recording medium is made to shrink by the fixation process is affected by the recording medium type, initial moisture content of the recording medium, etc. Thus, it is likely to be in a range of 100 μm-500 μm. Whether the shutdown control is executed or not, the positional relationship between the referential line (point) of a sheet of recording medium, and where on the sheet P an image is formed (transferred) remains the same. Thus, if a sheet P of recording medium is changed in length in terms of the recording medium conveyance direction after the transfer of an image onto the sheet P, the positional relations between the sheet P and the image thereon changes. That is, the prints outputted while the image formation system 1000 is under the stop avoiding control are different in the positional relationship between the sheet of recording medium and the image thereon from the prints outputted while the image formation system 1000 is under the normal control. Thus, the prints stacked in the large capacity stacker before the stop avoiding control begin to be executed are different in the positional relationship between the sheet of recording medium and the image thereon from those outputted after the stop avoiding control began.

The stacked prints in the large capacity stacker (603 in FIG. 1) are cut by a cutter to a preset size, in one of the post-processing operations, so that they become the same in size. The cutter cuts together a set of prints (substantial number of prints) along the cutting mark, which is printed as a part of each print. It is desired that after the cutting of the stacked prints (sheets of recording medium), the amount of positional deviation between the image of a print and the sheet P of the print falls within no more than 500 μm. If the deviation is no less than 500 μm, the positional difference between the page number on the front surface of a print and that on the back surface of the print is noticeable. Further, in a case where the cut prints are bound in the form of a book, the image on one of given two consecutive pages becomes substantially misaligned with the image on the other page. Therefore, it is not desirable that the shrinkage is no less than 500 μm.

Further, in a case where the downstream image forming apparatus 100A is not used for toner image formation, and is used for recording medium conveyance, each sheet P of recording medium is subjected to the fixation process by the fixing device 201B of the downstream image forming apparatus 100B after an image is formed on both surfaces of the sheet P. Therefore, not only does each sheet P of recording medium suffer from the problem that it is changed in length in terms of recording medium conveyance direction, but also, the problem that the image on one of the two surfaces of the sheet P becomes higher in gloss. Before the stop avoiding control is started, each of the two surfaces of each sheet P of recording medium is subjected to the fixation process only once; one surface is subjected to the fixation process by the image forming apparatus 100A, whereas the other surface is subjected to the fixation process by the image forming apparatus 100B. In comparison, after the starting of the stop avoiding control, each sheet P of recording medium is subjected to the fixation process a total of three time, that is, once by the image forming apparatus which is not used for image formation, and twice by the image forming apparatus which is operated in the two-side printing mode.

Further, if the stop avoiding control is carried out because the downstream image forming apparatus 100B has run out of toner, an image is formed on both surfaces of each sheet P of recording medium with the use of only the upstream image forming apparatus 100A, and then, the sheet P is subjected to the fixation process by the fixing device 201B of the downstream image forming apparatus 100B, that is, the third time. Thus, the problem that the print increases in gloss occurs. Generally speaking, a full-color print is higher in gloss than a monochromatic print, which is made with the use of only one developer, that is, black toner. Therefore, the effect of the fixation process upon the gloss of a full-color image is greater than that upon the gloss of a black-and-white (monochromatic image). Thus, the above-described problem is more serious when the image forming system 1000 is forming a full-color image than when it is forming a black-and-white image.

In the first embodiment, therefore, in a case where the image formation system 1000 is automatically switched in operational mode from the first mode to the second or third mode so that it can continue its operation in the two-sided printing mode, the gloss deviation problem attributable to the number of times a sheet P of recording medium is put through the fixing devices 201A and 201B is prevented, and also, the image position deviation problem attributable to the difference in the amount of recording medium shrinkage is prevented.

Referring to FIG. 11 along with FIG. 2, if the upstream image forming apparatus 100A runs out of toner, the control section 1501 reduces in temperature the fixing device 201A of the upstream image forming apparatus 100A, and then, begins to make only the upstream image forming apparatus 100B operate in the two-sided printing mode.

The control section 1501 detects the amount of the remaining toner in the toner supply bottle 7 with the use of a toner amount sensor 24. As it detects that the amount of the remaining toner in the toner supply bottle 7 is small, it makes the control panel 1504 display a warning that prompts an operator to replace, or refill, the toner supply bottle 7 (S401).

Further, after the control section 1501 displays the toner supply warning, it begins to count the number of prints outputted thereafter, and stores the count in a memory (S402). The image formation system 1000 can output roughly 2,000 prints before it completely runs out of toner after the toner supply warning is displayed. Ordinarily, therefore, as long as an operator supplies the image formation system 1000 with toner before roughly 2,000th print is outputted, that is, before the image formation system 1000 completely runs out of toner, the image formation system 1000 can continue to operate without any interruption. However, in a case where the image formation system 1000 is operated late at night, that is, when an operator is not readily available to attend to the image formation system 1000, and therefore, the image formation system 1000 is not supplied with toner within roughly an hour, that is, the length of time it takes for the image formation system 1000 to output roughly 2,000 prints, after the warning, the image formation system 1000 has to be stopped.

Thus, as the output counter reaches a preset number, which is 2,000 in this case (Yes in S403), the control section 1501 determines that the toner bottle 7 is virtually out of toner. As long as the image formation system 1000 is supplied with toner before the toner in the image formation system 1000 is completely consumed, the control section 1501 restores the normal control sequence without carrying out the stop avoiding control sequence. In the first embodiment, whether or not the image formation system 1000 has completely run out of toner is determined based on the print output count. However, it may be detected by providing the image formation system 1000 with a sensor which directly detects that the image formation system 1000 is out of toner, or totaling the video count of the outputted images.

In any case, as the control section 1501 determines that the image formation system 1000 is virtually out of toner (Yes in S403), it makes the image formation system 1000 finish the on-going image forming operation. Then, it temporarily prevents the image formation system 1000 from feeding a sheet P of recording medium into the image formation system 1000, and also, from forming an image. Then, it makes the image formation system 1000 discharge all the sheets P of recording medium, on which an image was partially formed (S404). These sheets P of recording medium (partially finished prints) have to be prevented from mixing up with the sheets P of recording medium which were discharged into the large capacity stacker and have the normal image. Therefore, the partially completed prints are conveyed to the upper tray of the large capacity stacker 603, and are stacked in the upper tray, so that they can be disposed together by an operator the next day.

Thereafter, the control section 1501 turns off the heater of the fixing device 201A of the upstream image forming apparatus 100A (S405). In a case where the image forming apparatus 100A is provided with a means for cooling its fixing device 201A, the control section 1501 starts cooling the fixing device 201A. Incidentally, directly cooling the fixation roller 11 makes shorter the length of time the image formation system 1000 has to be temporarily prevented from operating, being therefore more effective, than cooling the entirety of the fixing device 201A.

The controller 1501 defects a temperature of the fixing roller 211 of the upstream image forming apparatus 100A to check whether the temperature has lowered to 90° C., or lower which is the temperature with which the paper hardly expands or contracts (S406). The expansion and contraction of the paper occurs due to evaporation of the water content of the recording material P, and therefore, if the temperature is lower than 100° C. which is the evaporation temperature of the water, the expansion and contraction of the recording material P does not occur. In view of this, in Embodiment 1, the operation of the third mode is started after the decrease lowers to 90° C. which is less than 100° C.

It be considered that without waiting for the temperature to reach the temperature not causing the expansion and contraction of the recording material P, the magnification of the image data is changed in accordance with the degree of the expansion and contraction of the recording material P during the fixing, and the light image is reduced corresponding to the contraction of the recording material. However, the magnification change corresponding to the expansion and contraction of the recording material P due to the fixing operation is very small, and is different if the kind of the recording material P is different. Therefore, it is not easy to finely reduce image data continuously in accordance with the degree of the expansion and contraction of the recording material P in the process of the cooling of fixing roller 211.

When the temperature of the fixing roller 211 of the upstream image forming apparatus 100A is not more than 90° C. (Yes, in S406), the controller 1501 starts the feeding operation of the recording material P and the image forming operation in the third mode by the downstream image forming apparatus 100B (S407). The upstream image forming apparatus 100A does not carry out the toner image formation and feeds the recording material P fed from the feeding deck 601 and feeds it to the relay unit 301. The downstream image forming apparatus 100B forms the toner image and transfers it to the fed recording material P. Before the stage, in the first mode, the downstream image forming apparatus 100B effects only the one-side printing, but in the third mode, the apparatus effects the both sides printing operation by itself using the reversion feeding mechanism 30B. Then, the both sides printing is completed only by the downstream image forming apparatus 100B, and thereafter, the recording material P is fed to the downstream 602 and the large capacity stacker 603.

Thereafter, in the case that the toner is used up in the downstream image forming apparatus 100B during the stop avoiding control of the third mode, the third mode operation is stopped, by which the entire image forming apparatuses 100A, 100B are stopped, and waits for the toner supply.

Here, the description has been made as to the no-toner situation in the upstream image forming apparatus 100A, as an example. However, when the toner is used up in the downstream image forming apparatus 100B, the heater of the fixing device 201B of the downstream image forming apparatus 100B is forcefully stopped (S405). The operation waits for the temperature of the fixing roller 211 of the downstream image forming apparatus 100B to lower to not more than 90° C., and the both sides printing operation is carried out in the second mode using only the upstream image forming apparatus 100A, and the control is fundamentally the same.

As described in the foregoing, according to the control in Embodiment 1, when the no-toner occurs in the unattended operation, the stop avoiding control is automatically carried out, so that the output images can be produced with the satisfactory image positional accuracy without stop of the printing operation, although the output number per unit time is in half.

When the stop avoiding control is carries out for the downstream image forming apparatus 100B, the degree of the unnecessary increase of the glossiness of the image after the third fixing, even if it is carried out, is small, by decreasing the fixing roller temperature of the image forming apparatus 100B to not more than 90° C.

### Comparative Experiments

In order to check the effect of the control of Embodiment 1, the deviation in the position of the print image above recording material P and the change of the glossiness vs. the output number until the no-toner alarm is outputted, under the following three different conditions:

(1) no stop avoiding control is carried out (only the first mode);
(2) the stop avoiding control is carried out when the toner in the downstream image forming apparatus 100B is used up (the first mode and then the second mode); and
(3) the stop avoiding control is carried out with the temperature control for the fixing device when the toner in the downstream image forming apparatus 100B is used up (the first mode and then the second mode with waiting to 90° C.

Table 1 shows the positional deviation amounts and the measurements of the glossiness in the conditions (1)-(3).

TABLE 1

| | Outputted | | |
|---|---|---|---|
| | sheets | Positional | |
| | counts | alignment | Glossiness |
| No stop- | 2100 | Good | 10 |
| avoiding | | | |
| control | | | |
| Only stop- | 9450 | No good | 10 → 15 |
| avoiding | | | |
| control | | | |
| Fixing temp. | 9450 | Good | 10 → 11 |
| control + | | | |
| Stop | | | |
| avoiding | | | |
| control | | | |

The glossiness (60° glossiness) has been measured using a gloss meter PM-1 available from Nippon Denshoku Kogyo Kabushiki Kaisha, Japan. The output number is the total output number of both side images of A3 size when the no-toner occurs in the downstream image forming apparatus 100B during the first 1 hour in the 8 hour continuous operation.

As shown in Table 1, under the condition of the (1), the image forming operation stops simultaneously with the occurrence of no-toner, and therefore, the productivity is 2100 sheets by the first one hour. Under the condition (2) which is a comparison example condition, and the condition (3) which is the Embodiment 1 conditions,

By the stop avoiding control after the generation of the no-toner, the both sides printing continues with the productivity which is one half that in the first mode, and therefore, the number of the output images is as large as 9450 after 8 hours.

However, under the condition (comparison example) of the (2), the temperature control of the fixing device is not carried out, and therefore, the image position is deviated exceeding 500 μm at the maximum, due to the difference in the expansion and contraction degrees of the recording material P between before and after the occurrence of the no-toner situation.

This is discriminated as the unsatisfactory positional deviation images. Under the condition (Embodiment 1) of (3), the maximum deviation of the image position is less than 500 μm, and it is discriminated as the satisfactory image.

As to the glossiness of the print image, in the condition (comparison example) of (2), due to the increase of the number of the fixing operations to which the image is subjected to three by the, stop avoiding control, the glossiness rises from 10 to 15 after the occurrence of the no-toner situation. Under the condition (3) (Embodiment 1), the fixing temperature control is used, the change of the glossiness is from 10 to 11 approximately, and the good images are produced.

According to Embodiment 1, the tandem image forming apparatus system is operable in an operation mode in which the image is formed using the plurality of toner image forming portions and in an operation mode in which the image is formed using only one toner image forming portion. Therefore, even if an inoperability such as the no-toner situation occurs in one of the image forming apparatuses during the continuous operation, the both sides printing job can continue although the productivity is low.

### Embodiment 2

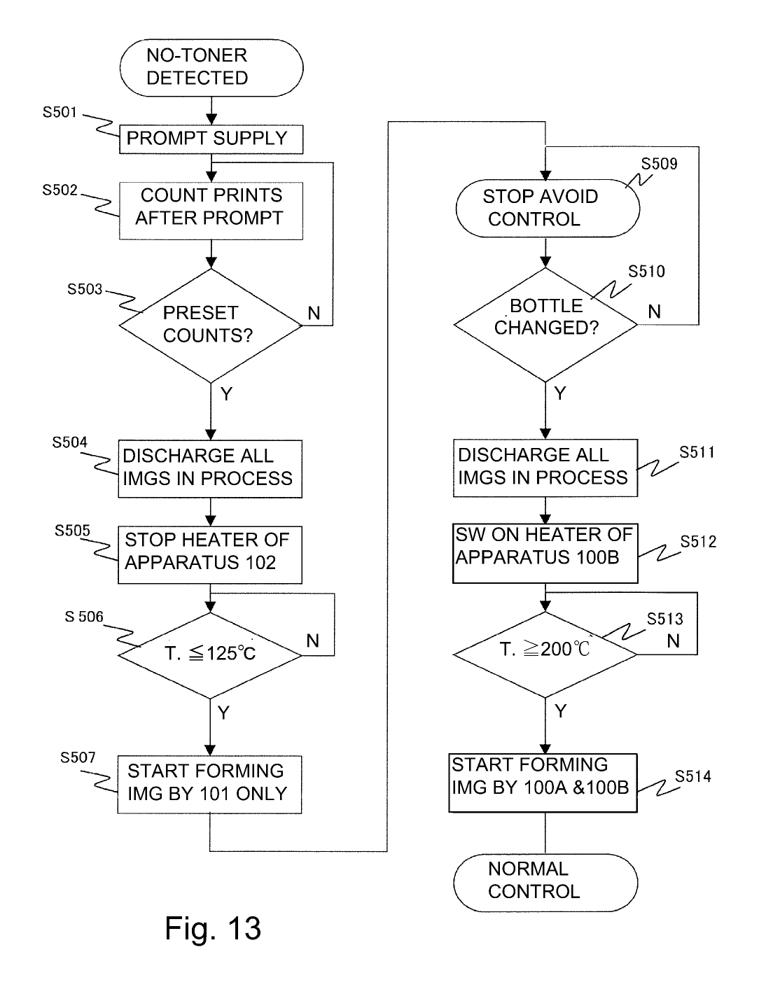

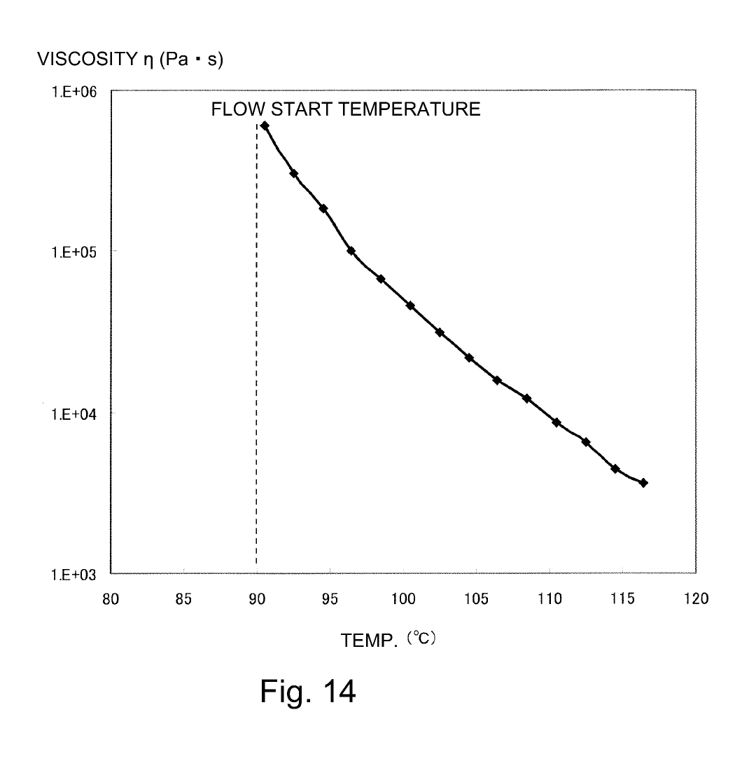

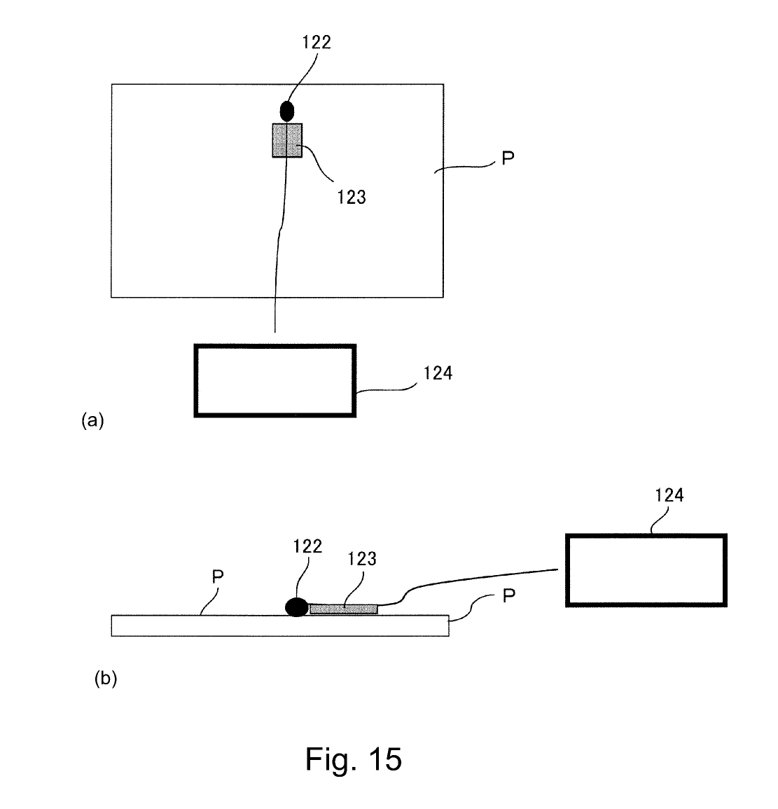

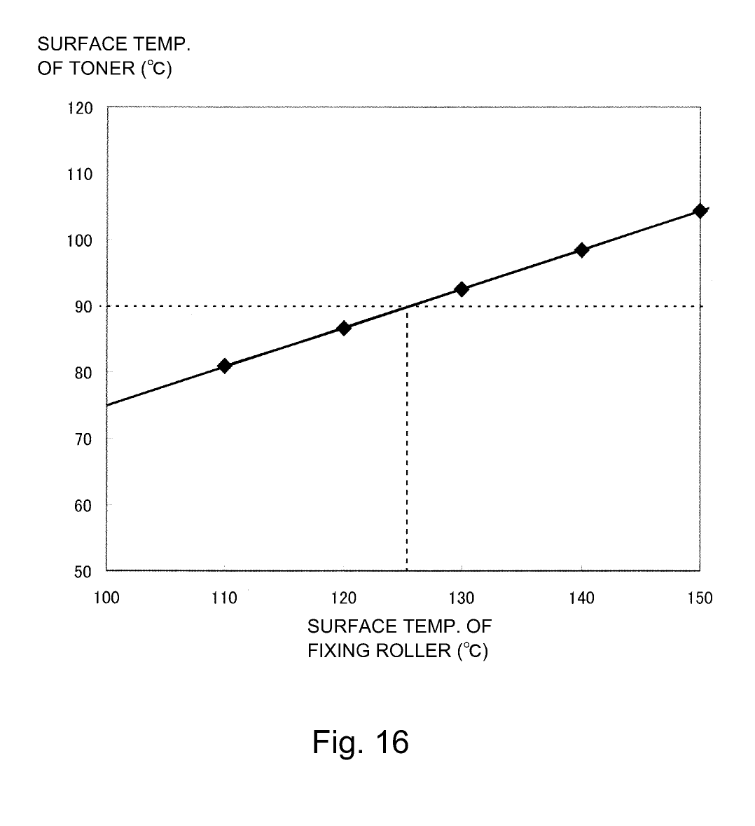

FIG. 13 is a flow chart of a stop avoiding control according to Embodiment 2. FIG. 14 is an illustration of a viscosity/temperature property of the toner. FIG. 15 is as schematic view of a measuring device used in measurement of the toner temperature during the fixing operation. FIG. 16 shows a relation between the surface temperature of the fixing roller and the toner temperature.

In Embodiment 2, the use is made with the image forming system 1000 of FIG. 1, and stop avoiding control is carried out with the lowered temperature of the fixing device with which the toner is use up, but the target temperature of the temperature lowering is different.

As shown in FIG. 13, in Embodiment 2, during the both sides printing in the first mode, when the toner is used up in the downstream image forming apparatus 100B, the temperature of the fixing device 201B is lowered, and the operation is switched to the second mode, and the both sides printing is continued using only the upstream image forming apparatus 100A.

When the remaining amount of the toner supplied from the toner supply bottle 7 decreases, the warning promoting the toner supply is displayed on the operation panel 1504 by the controller 1501. The controller 1501 counts the output number after the warning (S502), and when the predetermined number is counted (Yes in S503), the apparatus discharges all of the sheets which are in the process of image formation (S504). The discharged recording materials P are fed and stacked on a tray of the large capacity stacker 603, and the operator disposes of all of them on the next working day.

In order to avoid mixed stacking on the large capacity stacker 603 with the normal image formation recording materials P already printed up to this point of time.

The image forming apparatus 100B waits for the temperature of the fixing roller 211 thereof reaches 125° C. which is higher than the temperature in Embodiment 1, and then starts the both side printing in the second mode (S507). Thereafter, the temperature of the fixing roller 211 is maintained at 125° C., the both sides printing in the second mode is continued (S508). When the toner supply bottle 7 is exchanged (Yes in S509), the image forming operation is interrupted (S510), and the temperature of the fixing roller 211 is raised (S511) When the temperature of the fixing roller 211 rises to the normal temperature (Yes, in S512), the operation is automatically returned to the both sides printing of the first mode. When the abnormality in the toner image forming portion 101B during the execution of the second mode, the controller 1501 resets the temperature of the fixing device 201B to the temperature of the first mode to resume the first mode operation.

In Embodiment 2, the target temperature of the downstream fixing device 201B during the execution of the second mode is 125° C. In Embodiment 1, it is 90° C. which is the critical temperature avoiding the expansion and contraction of the recording material P, but in Embodiment 2, the target temperature of the fixing roller is 125° C. which is a critical temperature for avoiding the glossiness change of the toner. This is because the problem with the glossiness can be avoided if the glossiness of the fixed image formed by the upstream image forming apparatus 100A does not change when it passes through the fixing device 201B of the downstream image forming apparatus 100B, in the case that the toner is used up in the downstream image forming apparatus 100B.

In order to avoid the change of the glossiness of the fixed image, it will suffice if the temperature the toner on recording material P which is subjected to the heat pressing is lower than the critical temperature avoiding the deformation, that is, keeping the non-fluid state. In order to determine such a critical temperature, the melting viscosity property of the toner is measured using a flow tester CFT-500D available from Kabushiki Kaisha SHIMAZU SEISAKU SHO, Japan, by which the flowing start temperature of the toner is determined. FIG. 14 shows the results of the measurement.

The melting viscosity of the toner is measured in accordance with the operation manual of the flow tester under the following conditions:

(1) sample: 1.0 g of the toner is placed in a press molding device having a diameter of 1 cm and is molded therein by pressing it for one minute under the load of 20 kN, and the molded toner is used as the sample:
(2) die: the hole diameter is 1.0 mm: length is 1.0 mm: cylinder pressure is 9.807×10̂5 (Pa):
(3) measurement mode: temperature raising with the temperature rising speed of 4.0° C./min.

As shown in FIG. 14, the viscosity η (Pa·sec) of the toner is measured in the range of 50° C. to 200° C. The abscissa is a toner temperature, and the ordinate is a toner viscosity η. When the temperature of the toner rises, the melting viscosity of the toner lowers so that the toner is easy to deform. On the basis of the melting viscosity property of the toner, the temperature at which the flowing of the toner is determined, the flow starting temperature of the toner used in embodiment is 90° C. Under the condition not more than the flow starting temperature, the toner is non-fluid, and the toner is fluid in the temperature not less than the flow starting temperature such that the melted toner flows out through the die of the flow tester.

However, even if the flow starting temperature of the toner is 90° C., it is not necessary to lower the target temperature of the fixing roller 211 to 90° C. There is a temperature difference between the recording material and the fixing roller 211 during the fixing operation, and therefore, even if the target temperature of the fixing roller 211 is set at not less than 90° C., the surface of the recording material is maintained at a temperature less than 90° C. In view of this, the toner temperature during the fixing operation in the fixing device 201B was actually measured to determine the limit temperature of the fixing roller 211 with which the surface of the recording material can be maintained less than 90° C.

As shown in FIG. 15, the toner temperature on the surface of the recording material was measured. In the toner temperature measurement during the fixing, an extra-thin thermocouple KFST-10-100-200 (thermocouple 122) available from ANBE SMT Kabushiki Kaisha having a free end diameter of Φ50 μm. It was fixed by a KAPTON tape 123 (Registered Trademark) available from 3M Company so as to expose the free end contact portions of the thermocouple 122. The temperature data measured by the thermocouple 122 is recorded by a memory high coder 8855 (recorder 124) available from HIOKI Kabushiki Kaisha, Japan.

With such a structure, the recording material P and the thermocouple 122 are passed through the fixing device 201B, and the temperature provided by the thermocouple during the fixing operation is recorded as the toner temperature. The temperature provided by the thermocouple immediately after the passage through the fixing device 201B is taken as the toner surface temperature during the fixing. FIG. 16 shows the results of measurement of the surface temperature of the fixing roller and the toner surface temperature. The fixing roller surface temperature in the abscissa is the target temperature of the fixing roller 211, and the toner surface temperature in the ordinate rises substantially linearly when the surface temperature of the fixing roller is high. In the Figure, the broken line at 90° C., of the toner surface temperature indicates the toner flow starting temperature measured by the flow tester. From this relation, it is understood that the surface temperature of the toner is not less than the flow starting temperature when the fixing roller surface temperature is not less than 125° C. In consideration of these results, in the stop avoiding control in Embodiment 2, the target temperature for the fixing roller 211 is 125° C.

Forming apparatus using such a control, the similar evaluation to Embodiment 1 was carried out, and it was confirmed that also in Embodiment 2, the difference in glossiness does not exist as in Embodiment 1 before and after the stop avoiding control. In Embodiment 2, the target temperature of the fixing device 201B in the second mode is 125° C.

The temperature is different depending on the flow starting temperature of the used toner determined by the melting viscosity property and the fixing conditions. Therefore, the specific temperature of 125° C. its not inevitable to the present invention.

### Embodiment 3

In Embodiments 1, 2, the low-toner situation occurs in one of the image forming apparatuses 100A, 100B with the result that the image forming operation is disabled. However, the present invention is not limited to the low-toner situation during the image forming operation.

For example, when the collected toner container for temporarily storing collected toner by the drum cleaning device becomes full, the image forming operation has to be stopped, too. Also in such a case, the first mode is used as a base mode, and the stop avoiding control can be executed by which the operation is automatically switched to the second mode or the third mode.

By doing so, the stop of the image forming system during the all-night operation can be avoided.

In addition, when a corona charger is used, an image density defect or the like may occur due to the discharge wire disconnection, the lifetime ending of the developer in developing device, the improper charging, the patch detection defect. Even in such a case, the stop avoiding control can be carried out similarly, if the sheet feeding performance is in order.

In the image forming system of the present invention, the temperature of the second heating portion in the second mode is lower than the temperature of said second heating portion at said first mode, and therefore, such a re-heating of the image as results in the change of the glossiness by second image heating portion.

While the invention has been described with reference to the structures disclosed herein, it is not confined to the details set forth, and this application is intended to cover such modification or changes as may come within the purposes of the improvements or the scope of the following claims.

This application claims priority from Japanese Patent Application No. 044183/2011 filed Mar. 1, 2011, which is hereby incorporated by reference.

What is claimed is:

1. An image forming system comprising:
a first image forming station including a first toner image forming portion for forming a toner image and for transferring the toner image onto a recording material, and a first image heating portion for heating the toner image formed on the recording material by said first toner image forming portion;
a second image forming station including a second toner image forming portion for forming a toner image and for transferring the toner image formed by said second toner image forming portion onto the recording material received from said first image heating portion, and a second image heating portion for heating the toner image formed on the recording material by said second toner image forming portion;
a controller capable of executing an operation in a first mode in which a predetermined image formation in accordance with an inputted image forming condition is effected using said first image forming station and said second image forming station,
a second mode in which the predetermined image formation is effected without using said second toner image forming portion; and
a temperature controller for controlling a temperature of said second image heating portion in the second mode so as to be smaller than a temperature of said second image heating portion in the first mode.

2. A system according to claim 1, wherein when an abnormality occurs in said second toner image forming portion during the operation in the first mode, said controller effects control such that the operation of the second mode is started after the temperature of said second image heating portion reaches a temperature not higher than a predetermined temperature.

3. A system according to claim 1, wherein when an abnormality occurs in said second toner image forming portion during the operation of the first mode, said controller effects control so as to discharge the recording material existing between said first toner image forming portion and said second image heating portion through said second image heating portion, and then to lower the temperature of said second image heating portion.

4. A system according to claim 2, wherein the abnormality of said second toner image forming portion during the operation of the second mode is removed, said controller effects control so as to restore the temperature of said second image heating portion to the temperature of the first mode and then resume the operation of the first mode.

5. A system according to claim 1, further comprising a reversion feeding mechanism for reversing a facing orientation of the recording material having the image formed by said first toner image forming portion and said first image heating portion and refeeding the reversed recording material into said first toner image forming portion, wherein said controller controls the image formation for both side image formation only by said second toner image forming portion and said second image heating portion using said reversion feeding mechanism in the operation in the second mode.

6. A system according to claim 1, wherein said controller sets, for said first toner image forming portion in the second mode, an image forming speed which is lower than in the first mode.

7. A system according to claim 1, wherein said controller is capable of executing the operation in a third mode in which said first toner image forming portion is not used, wherein in the operation of the third mode, said temperature controller controls the temperature of the first image heating portion in the second mode so as to be smaller than a temperature of said second image heating portion in the first mode.
